(19) United States
(12) Patent Application Publication
(10) Pub. No.: US 2004/0102959 A1
(43) Pub. Date: May 27, 2004

(54) Authentication methods apparatus, media and signals

(76) Inventor: Ron Shimon Estrin, Columbia (CA)

Correspondence Address: Ralph A Dowell, Dowell & Dowell, Suite 309, 1215 Jefferson Davis Highway, Arlington, VA, 22202, US

(21) Appl. No.: 10/473,081

(22) PCT Filed: Mar. 28, 2001
(86) PCT No.: PCT/CA01/00401

(51) Int. Cl. G06F 17/20

(52) U.S. Cl. 704/8

(57) ABSTRACT

Authentication methods, apparatuses, media and signals arc disclosed. A first authentication method involves receiving an authentication voice sample of a user of a tile, and associating the authentication voice sample with the tile to indicate approval by the user or contents of the tile. A second authentication method involves receiving an authentication voice sample, of a user of a file, associated with the file to indicate approval by the user of contents or the file, and further involves validating the authentication voice sample.

### FIELD OF THE INVENTION

The present invention relates to authentication, and more particularly to authentication methods, apparatuses, media and signals.

### BACKGROUND OF THE INVENTION

With the rapid proliferation of digital communications technologies such as the Internet and e-mail in recent years, the use of digital documents and other electronic files has become increasingly widespread. Many businesses are already in the process of attempting to implement “paperless offices” where all relevant documents exist in electronic form only. Many other businesses, while not yet striving for such a goal, nevertheless wish to maximize their use of electronic documents and electronic communications as a more cost-effective alternative to paper documents, mail, courier services and facsimile machines.

Digital signatures pose a particular challenge to users of electronic documents or other electronic files. For example, if a user were to “sign” an electronic document by simply copying a bitmap image of his or her signature into the document, this would pose a security risk, as any recipient of the document would then be able to alter the contents of the document after the signature was attached, to make it appear that the user had approved of or agreed to terms or other content that the user had not in fact approved. Similarly, any recipient of the document would be able to easily copy the bitmap image to other electronic documents to forge the user's signature. For this reason, such images are generally not accepted as adequate proof that a user has “signed” an electronic document, as it would be too easy for the user to repudiate the document, or in other words, to deny that he or she approved or signed the particular document.

Accordingly, digital signatures are frequently implemented using the Public Key Infrastructure (PKI). For example, a user may obtain a digital certificate from a Certification Authority. A key pair, consisting of a private key and a corresponding public key, are associated with the digital certificate. Information encrypted with the private key may only be decrypted by using the public key, and vice versa. The private key is intended to be kept secret, on the user's machine. When the user wishes to electronically “sign” a document, the private key is used by an encryption algorithm to encrypt the document (or more frequently to encrypt a smaller digest of the document to conserve processing power). The document may then be forwarded to other recipients, along with the user's public key, to be used to decrypt the encrypted document (or digest thereof). The certification authority which issued the certificate to the user is responsible for verifying the identity of the user who bears the public key and encodes identification information within the digital certificate. Accordingly, if the recipient of the document is able to successfully decrypt the encrypted document (or digest thereof) using the public key included with the document, that recipient may have confidence that the identification information contained within the certificate is correct, at least, to the degree that the recipient has trust and confidence in the diligence of issuing certificate authority in confirming the identity of the party to whom the digital certificate was issued.

However, this approach suffers from a number of difficulties. Logically, the ability to decrypt the document (or digest thereof) using the public key proves nothing more than that the document (or digest) was encrypted using the user's private key. It does not prove that the user, as opposed to someone else, used the private key to “sign” or encrypt the document. Thus, anyone with physical access to the user's computer in which the private key is stored (or with access to a storage media such as a smart card where the private key may be stored), or even a hacker accessing the user's computer from a remote location, may effectively forge the user's “signature” by using the user's private key to sign documents. Thus, even this type of digital signature does not provide an entirely reliable indication that the user (as opposed to someone else who has gained unauthorized access to the user's private key) did in fact approve or sign the contents of the document. Some jurisdictions, notably including Washington and Utah, USA, have enacted legislation that prohibits the user from repudiating any document signed using the user's private key, if the user's keys have been certified by a Certification Authority. In such jurisdictions, therefore, these technical shortcomings present a significant risk to a user that he or she will be held liable for signing contractual or other documents that the user did not in fact sign, which in turn may also deter users from obtaining digital certificates from Certification Authorities. Conversely, in most other jurisdictions, which do not have such laws, from the point of view of recipients of digitally signed documents, there is a significant risk that the purported signor will be able to repudiate his or her signature and deny any obligations that would otherwise have resulted.

In addition, Certification Authorities typically offer different types of digital Certificates at different price levels, with correspondingly different levels of security. Although the most expensive types of digital certificates usually involve careful inquiries by the Certification Authority to ascertain the identity of the entity to whom the certificate is being issued, these certificates are quite expensive, often costing several hundred dollars per year or more, and these costs are therefore prohibitive to most individuals and to many small businesses. Even the cheapest price levels deter many users from acquiring digital certificates, as they view them as unnecessary. In addition, the cheaper types of digital certificates often involve minimal inquiries by the Certification Authority, and it is therefore possible for individuals to obtain such digital certificates using false or fictitious names. This further diminishes the reliability of such digital signatures, and, in those cases where the certificate was issued in the name of an entity that actually exists, increases the risk that the entity will repudiate its signature and allege that someone else obtained the certificate in its name.

It is possible for private/public key pairs to be used to sign documents in the above manner without obtaining a digital certificate from a Certification Authority, a process sometimes referred to as self-signing. However, without the benefit of a trusted third party such as a Certification Authority to verify the identity of the owner of the key pair, the already-questionable ability to link the public key to a particular individual or entity is severely if not entirely diminished. Although it may be possible to verify that a particular machine was used to sign the document by comparing the public key from the document with private/public key pairs stored on the machine, a signor who wishes to repudiate his or her signature may simply conceal the machine to prevent such analysis. Even if the machine is available and it is confirmed that the public key matches a private/public key pair stored on the machine, this still fails to prove that the document was signed by a particular person, as opposed to anyone else who had authorized or unauthorized physical or remote access to the machine or to the private/public key pair.

In other unrelated technical fields, fingerprint scanners and retinal scanners for example, have been employed to reliably confirm the identity of an individual, for the purpose of granting or denying access to physical premises, for example. However, such scanning devices are generally prohibitively expensive for casual individual use, and would therefore not be suitable for widespread use for digital signature purposes. In addition, many individuals, due to privacy concerns, would not be willing to provide such information to either document recipients or signature confirmation authorities to confirm signature or approval of a document.

Accordingly, there is a need for an improved authentication method for authenticating a user's approval of a document or other electronic file.

### SUMMARY OF THE INVENTION

The present invention addresses the above need by providing, in accordance with a first embodiment of the invention, an authentication method. The method includes receiving an authentication voice sample of a user of a file, and associating the authentication voice sample with the file to indicate approval by the user of contents of the file.

By associating the user's authentication voice sample with the file to indicate the user's approval of its contents in the above manner, the reliability of the user's approval is improved. For example, this may allow the user's authentication voice sample to be played back by a recipient, who in many cases will be sufficiently familiar with the user to recognize the user's voice. Even in cases where the recipient is not familiar with the user's voice, the association of the user's authentication voice sample may be used by the recipient to prove that the user approved the contents of the file and thereby prevent the user from repudiating such approval, if the user did in fact approve the file by providing the authentication voice sample.

Associating the authentication voice sample with the file preferably includes associating, as the authentication voice sample, a unique utterance uttered by the user. This may include generating a unique affirmation script, which may include generating a random phrase or a random sentence, for example.

Such features effectively require the user to associate a new, unique utterance with each new document whose contents are to be approved by the user, rather than simply using the same voice sample over and over again. This prevents an unauthorized party from surreptitiously copying an authentication voice sample the user had associated with a previous file, and associating it with a different file to forge the user's approval of the different file.

Generating the unique affirmation script may involve randomly selecting an entry in a lexicon, which may be achieved by generating a random number and using the number to address an entry location in the lexicon, for example.

Similarly, generating the unique affirmation script may include randomly selecting a plurality of words and assembling the words into the script. This may include randomly selecting a verb from a verb lexicon, randomly selecting a noun from a noun lexicon, randomly selecting an adjective from an adjective lexicon, and randomly selecting a preposition from a preposition lexicon, for example.

Associating the unique utterance with the file preferably includes prompting the user to utter, as the unique utterance, the unique affirmation script.

The method preferably involves speech-to-text converting the unique utterance to produce a textual representation of the unique utterance. If so, then the method preferably further involves comparing the textual representation to the unique affirmation script. The method may then include prompting the user to re-utter, as the unique utterance, the unique affirmation script, if the textual representation does not match the unique affirmation script.

Thus, in such an embodiment, if the utterance by the user of the unique affirmation script was not recognizable for any reason, then the user is prompted to re-record the authentication voice sample until the recorded authentication voice sample is a recognizable utterance of the unique affirmation script. This provides an extra degree of security against subsequent repudiation by the user of the user's approval of a particular file, as it precludes the user from arguing that the recorded authentication voice sample is not an utterance of the corresponding unique affirmation script which is uniquely associated with the particular file.

Associating the authentication voice sample with the file preferably includes storing the authentication voice sample in association with the file. In this regard, storing may involve receiving signals produced in response to an utterance by the user and storing, as the authentication voice sample, data representing the signals.

Storing may involve storing the sample in association with an object in the file, which may include storing the sample in association with a representation of a signature of the user, for example.

Storing may also involve storing the sample in the file, which may be achieved by storing the sample in an embedded stream in the file. This may involve storing the sample in an object pool portion of a document file, for example.

If desired, storing may further include storing a timestamp in association with the authentication voice sample. This may involve retrieving the timestamp from a remote time server.

Storing preferably involves storing a validation value in association with the authentication voice sample. This preferably involves generating the validation value in response to contents of the file. For example, generating the validation value may include executing a hashing function to produce a digital digest as the validation value. In any event, the validation value is preferably generated in response to a unique affirmation script portion of the file. Alternatively, or in addition, the validation value may be calculated in response to other contents, if desired. For example, the validation value may be generated in response to contents of a text portion, a unique affirmation script portion, a signature image portion and an authentication voice sample portion of the file.

Preferably, however, the validation value is generated in response to contents of the file excluding authentication objects that include authentication voice samples other than the authentication voice sample. This permits counter-signing, or in other words, a second user's authentication voice sample may be associated with the file to indicate the second user's approval of contents of the file, without invalidating a first user's authentication voice sample which has already been associated with the file to indicate the first user's approval thereof.

Storing the validation value may include encrypting the validation value to produce an encrypted validation value and storing the encrypted validation value in association with the authentication voice sample.

If desired, storing may further include storing a hyperlink in association with the authentication voice sample.

Storing may also include activating a revision history feature of the file when the authentication voice sample has been associated with the file.

The method may further involve validating the authentication voice sample. This may include indicating invalidity of the authentication voice sample if approved contents of the file have changed subsequent to association of the authentication voice sample with the file to approve the approved contents.

In accordance with another aspect of the invention, there is provided an authentication method. The method includes receiving an authentication voice sample, of a user of a file, associated with the file to indicate approval by the user of contents of the file. The method further includes validating the authentication voice sample.

Thus, a recipient of the file may not only receive the user's authentication voice sample confirming the user's approval of the file, but may also validate the voice sample, to provide the recipient with an additional degree of security against non-repudiation.

Validating preferably includes indicating invalidity of the authentication voice sample if approved contents of the file have changed subsequent to association of the authentication voice sample with the file to approve the approved contents.

For example, validating the authentication voice sample may include generating a validation value in response to contents of the file and comparing the validation value to a stored validation value associated with the authentication voice sample. Validating may further involve indicating validity of the authentication voice sample if the validation value matches the stored validation value, and otherwise indicating invalidity of the authentication voice sample. In this regard, generating a validation value may include executing a hashing function to produce a digital digest as the validation value. In any event, the validation value is preferably generated in response to a unique affirmation script portion of the file. Alternatively, the validatoin value may be generated in response to contents of a text portion, a unique affirmation script portion, a signature image portion and an authentication voice sample portion of the file, for example. In any event, the validation value is preferably generated in response to contents of the file excluding authentication objects that include authentication voice samples other than the authentication voice sample, to permit counter-signing by a second party without invalidating the first party's approval. Validating may further include decrypting an encrypted stored validation value to extract the stored validation value.

Alternatively, or in addition, validating may include audibly playing the authentication voice sample. Validating may further include displaying a unique affirmation script indicative of expected contents of the authentication voice sample, in which case a recipient may compare the unique affirmation script to the audibly played voice sample, if desired.

Alternatively, or in addition, validating may include comparing signals representing the authentication voice sample to signals representing a comparison voice sample. Thus, if a person who appears to have associated his or her authentication voice sample to indicate approval of the file denies having done so and thus wishes to repudiate such approval, the person may be requested to provide the comparison voice sample for the purpose of determining whether or not the authentication voice sample was in fact spoken by the person in question.

In accordance with another aspect of the invention, there is provided an authentication apparatus. The apparatus includes means for receiving an authentication voice sample of a user of a file, and further includes means for associating the authentication voice sample with the file to indicate approval by the user of contents of the file. If desired, the apparatus may further include means for carrying out various other functions disclosed herein.

In accordance with another aspect of the invention, there is provided an authentication apparatus, including means for receiving an authentication voice sample, of a user of a file, associated with the file to indicate approval by the user of contents of the file. The apparatus further includes means for validating the authentication voice sample. If desired, the apparatus may further include means for carrying out various other functions disclosed herein.

In accordance with another aspect of the invention, there is provided a computer-readable medium storing codes for directing a processor circuit to receive an authentication voice sample of a user of a file, and to associate the authentication voice sample with the file to indicate approval by the user of contents of the file. If desired, the medium may further include codes for directing the processor circuit to carry out various other aspects of the methods disclosed herein.

In accordance with another aspect of the invention, there is provided a computer-readable medium storing codes for directing a processor circuit to receive an authentication voice sample of a user of a file, associated with the file to indicate approval by the user of contents of the file, and to validate the authentication voice sample. If desired, the medium may further include codes for directing the processor circuit to carry out various other aspects of the methods disclosed herein.

In accordance with another aspect of the invention, there is provided a signal embodied in a carrier wave. The signal includes code segments for directing a processor circuit to receive an authentication voice sample of a user of a file, and to associate the authentication voice sample with the file to indicate approval by the user of contents of the file. If desired, the signal may further include code segments for directing the processor circuit to carry out various other aspects of the methods disclosed herein.

In accordance with another aspect of the invention, there is provided a signal embodied in a carrier wave, the signal including code segments for directing a processor circuit to receive an authentication voice sample of a user of a file, associated with the file to indicate approval by the user of contents of the file. The signal further includes code segments for directing the processor circuit to validate the authentication voice sample. If desired, the signal may further include code segments for directing the processor circuit to carry out various other aspects of the methods disclosed herein.

In accordance with another aspect of the invention, there is provided an authentication apparatus. The apparatus includes a processor circuit configured to receive an authentication voice sample of a user of a file, and to associate the authentication voice sample with the file to indicate approval by the user of contents of the file. If desired, the processor circuit may be further configured to carry out various other aspects of the methods disclosed herein.

In accordance with another aspect of the invention, there is provided an authentication apparatus including a processor circuit configured to receive an authentication voice sample, of a user of a file, associated with the file to indicate approval by the user of contents of the file. The processor circuit is further configured to validate the authentication voice sample. If desired, the processor circuit may be further configured to carry out various other aspects of the methods disclosed herein.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a block diagram of an authentication apparatus according to a first embodiment of the invention;

FIG. 2 is a block diagram of an authentication apparatus, computer readable media, and signals embodied in carrier waves, according to a second embodiment of the invention;

FIG. 3 is a flow chart of a signature generation routine executed by a processor circuit of the apparatus shown in FIG. 2;

FIG. 4 is a screen shot of a file being edited under the direction of an application program in conjunction with the signature generation routine shown in FIG. 3;

FIG. 5 is a screen shot the file shown in FIG. 4 after insertion of a signature image under the direction of the signature generation routine shown in FIG. 3;

FIG. 6 is a screen shot of a digital certificates dialogue window generated by the processor circuit shown in FIG. 2 under the direction of the signature generation routine shown in FIG. 3;

FIG. 7 is a screen shot of a signature image dialogue window generated by the processor circuit shown in FIG. 2 under the direction of the signature generation routine shown in FIG. 3;

FIGS. 8 and 9 are a flow chart of a signing subroutine of the signature generation routine shown in FIG. 3, executed by the processor circuit shown in FIG. 2;

FIG. 10 is a tabular representation of lexicons stored within an authentication resource shown in FIG. 2;

FIG. 11 is a screen shot of a signing options dialogue window generated by the processor circuit shown in FIG. 2 under the direction of the signing subroutine shown in FIGS. 8 and 9;

FIG. 12 is a flow chart of operational modes including a signature authentication routine executed by the processor circuit shown in FIG. 2;

FIG. 13 is a screen shot of a validation dialogue window generated by the processor circuit shown in FIG. 2 under the direction of the signature authentication routine shown in FIG. 12, indicating a valid authentication voice sample;

FIG. 14 is a screen shot of a validation dialogue window generated by the processor circuit shown in FIG. 2 under the direction of the signature authentication routine shown in FIG. 12, indicating an invalid authentication voice sample;

FIG. 15 is a screen shot of a details dialogue window generated by the processor circuit shown in FIG. 2 under the direction of the signature authentication routine shown in FIG. 12;

FIG. 16 is a screen shot of the file and signature image shown in FIG. 5, including a second signature image which has been inserted into the file without invalidating an authentication voice sample associated with the first signature image;

FIG. 17 is a screen shot of a file including a hyperlink and including a signature image as shown in FIG. 5, as viewed by an application program that does not have the signature authentication routine shown in FIG. 12 installed;

FIG. 18 is a flow chart of an optional voice comparison subroutine of a signature authentication routine shown in FIG. 12; and

FIG. 19 is a screen shot of a file that has been altered subsequent to activation of a revision history feature by the signing subroutine shown in FIGS. 8 and 9.

### DETAILED DESCRIPTION

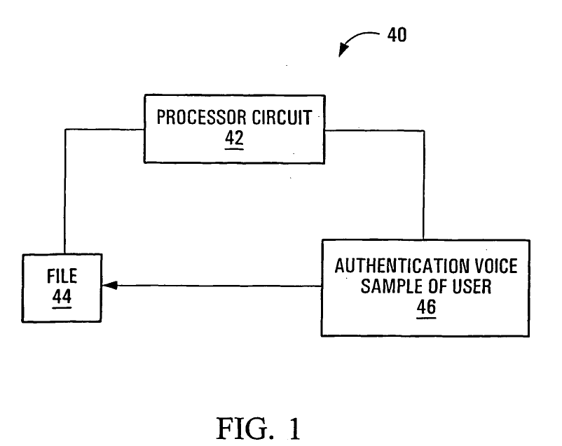

Referring to FIG. 1, an authentication apparatus according to a first embodiment of the invention is shown generally at 40. In this embodiment, the apparatus 40 includes a processor circuit shown generally at 42, configured to receive an authentication voice sample 46 of a user of a file 44, and to associate the authentication voice sample 46 with the file 44 to indicate approval by the user of contents of the file 44.

### System

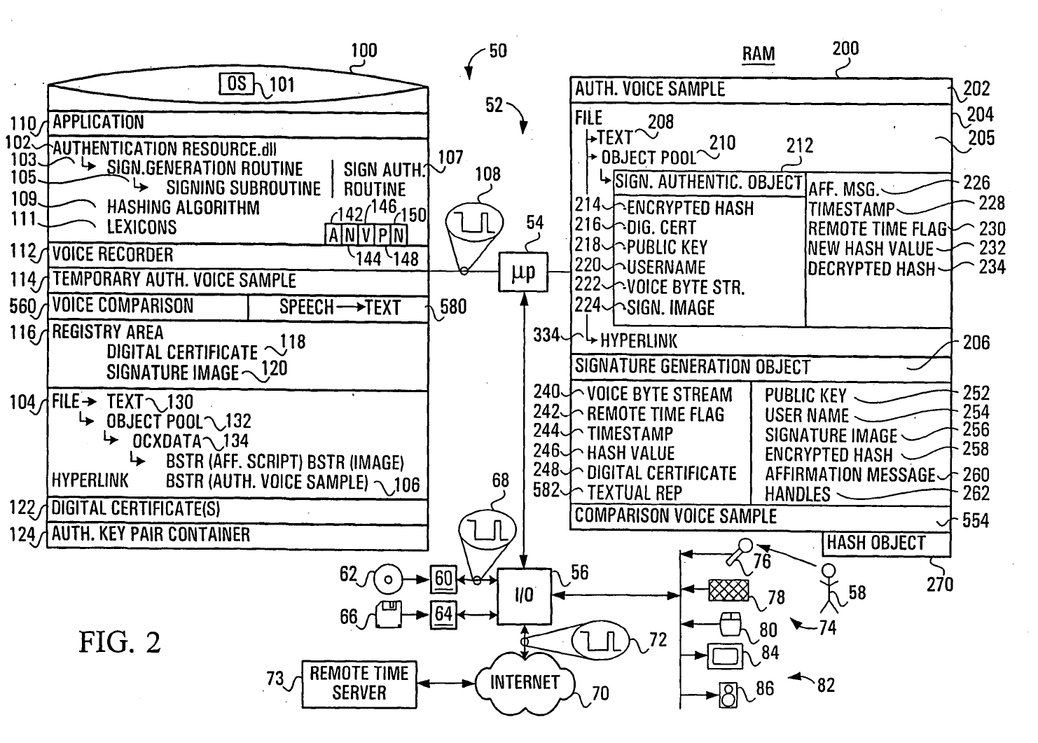

Referring to FIG. 2, an authentication apparatus according to a second embodiment of the invention is shown generally at 50. The apparatus 50 includes a processor circuit shown generally at 52, which in this embodiment includes a microprocessor 54 in communication with an input-output interface 56, a storage medium 100 which in this embodiment includes a hard disk drive, and a random access memory (RAM) 200.

In this embodiment, the storage medium 100 stores an operating system 101, and further stores a plurality of routines and files, including an authentication resource 102 and a file 104. In this embodiment, the authentication resource 102 configures the processor circuit 52 to receive an authentication voice sample 106 of a user 58 of the file 104, and to associate the authentication voice sample 106 with the file 104 to indicate approval by the user 58 of at least some contents, such as a text portion 130 for example, of the file 104. Similarly, in this embodiment, the authentication resource 102 configures the processor circuit to receive an authentication voice sample, such as the authentication voice sample 106 of the user 58 of the file 104 associated with the file 104 to indicate approval by the user 58 of contents of the file 104, and further configures the processor circuit to validate the authentication voice sample.

Thus, in this embodiment, the storage medium 100 acts as a computer readable medium storing codes for directing the processor circuit 52 to receive the authentication voice sample 106 of the user 58 of the file 104, and to associate the authentication voice sample 106 with the file 104, to indicate approval by the user 58 of contents of the file 104. Similarly, in this embodiment, the storage medium 100 acts as a computer readable medium storing codes for directing the processor circuit 52 to receive an authentication voice sample such as the authentication voice sample 106 of the user 58 of the file 104 associated with the file 104 to indicate approval by the user 58 of contents of the file 104, and for directing the processor circuit to validate the authentication voice sample.

Alternatively, however, other computer readable media storing such codes may be substituted. For example, in this embodiment, the processor circuit 52 is in communication, via the I/O interface, with a CD read/write drive 60 for reading data from and writing data to compact disks such as that shown at 62, and is similarly in communication with a floppy diskette drive 64 for reading from and writing to floppy diskettes such as that shown at 66. Therefore, if desired, other such media may be substituted.

More generally, it will be appreciated that media such as the storage medium 100, the CD 62 and the floppy diskette 66 are merely particular means of generating a signal embodied in a carrier wave, such as a signal 108 or a signal 68 shown in FIG. 2 for example, the signal including code segments for directing the processor circuit 52 to receive the authentication voice sample 106 of the user 58 of the file 104, and to associate the authentication voice sample 106 with the file 104 to indicate approval by the user 58 of contents of the file 104.

Alternatively, other ways of generating such signals may be substituted. For example, in this embodiment, the processor circuit 52 is in communication via the I/O interface 56 with a network shown generally at 70 which in this embodiment includes the Internet, via which the processor circuit is in communication with a myriad of other devices. Thus, in this embodiment, the processor circuit 52 may receive such a signal embodied in a carrier wave, such as the signal shown generally at 72 in FIG. 2, from a remote server via the network 70. The signal 72 may include codes for directing the processor circuit to carry out various functions described herein.

These examples and other such media or other ways of generating such signals will be apparent to one of ordinary skill in the art when presented with this specification and are not considered to depart from the scope of the invention as construed in accordance with the accompanying claims. Similarly, the microprocessor 54 is merely one example of a suitable processor circuit 52 and alternatively therefore, any other suitable types of processor circuits may be substituted.

In addition, in this embodiment the processor circuit 52 is in communication, via the I/O interface 56 and the network 70, with a remote time server 73, for retrieving a timestamp therefrom.

In the present embodiment the processor circuit 52 is in further communication via the I/O interface 56 with a number of user input devices shown generally at 74, including a microphone 76, a keyboard 78 and a mouse 80. The processor circuit 52 is similarly in communication with output devices shown generally at 82, which in this embodiment include a monitor 84 and amplified speakers 86. In this embodiment the apparatus 50 is housed within a laptop computer, and accordingly, in the present embodiment the aforementioned user input and output devices are built-in components of the laptop, without the need for external hardware. However, it will be appreciated that the apparatus 50 may be implemented in a myriad of alternative physical embodiments if desired.

Generally, the storage medium 100 stores a plurality of routines and files related to implementation of the present embodiment of the invention. More particularly, in this embodiment, the storage medium 100 stores an application program 110, which in this embodiment includes a word processor or more particularly, Microsoft Word 2002.

Similarly, in this embodiment, the authentication resource 102 includes a dynamic link library (.dll) resource which is linked to the application program 110, so that the authentication resource 102 is automatically loaded and a signature generation routine 103 of the authentication resource 102 is automatically executed whenever the application program 110 is executed by the processor circuit 52.

In this embodiment, the authentication resource 102 includes the signature generation routine 103, which further includes a signing subroutine 105. The authentication resource 102 further includes a signature authentication routine 107, a hashing algorithm shown generally at 109 and a plurality of lexicons shown generally at 111.

In this embodiment, the signing subroutine 105 configures the processor circuit 52 to receive the authentication voice sample 106 of the user 58 of the file 104 and to associate the authentication voice sample with the file.

Similarly, in this embodiment the signature authentication routine 107 configures the processor circuit to receive the authentication voice sample 106 and to validate it, and is also used for further signature authentication functionality as described in greater detail herein.

The hashing algorithm 109 configures the processor circuit 52 to calculate a validation value over contents of the file 104.

The lexicons 111 are used by the processor circuit 52 to generate a unique affirmation script and include an adjective lexicon 142, a first noun lexicon 144, a verb lexicon 146, a preposition lexicon 148 and a second noun lexicon 150. In this regard, in this specification, including the claims, the word “script” is used in its ordinary sense, for example (without limitation), to indicate any recognizable content that is to be spoken by a person, such as recognizable words, phrases, sentences, letters, numbers, syllables, sounds, or combinations thereof to be spoken by the person, for example. Thus, the word “script” is not intended to be restricted to any technical meaning that may apply in certain technical fields.

In this embodiment, the storage medium 100 further stores a voice recorder application 112, which in this embodiment includes a Windows Media Player. The storage medium 100 further stores a temporary authentication voice sample file 114 recorded by the voice recorder application 112.

In this embodiment, the storage medium 100 further includes a registry area 116 corresponding to the authentication resource 102, in which a digital certificate file 118 and a signature image file 120 are stored.

The storage medium 100 further stores one or more digital certificates 122 and an authentication public/private key pair container 124.

In this embodiment, the various routines stored in the storage medium 100 direct the processor circuit 52 to define, in the RAM 200, a plurality of registers or stores, including an authentication voice sample register 202, a file store 204, a signature generation object 206, and various other registers, fields, stores and objects, as described in greater detail below.

The authentication voice sample register 202 is used by the voice recorder application 112 for temporarily storing an authentication voice sample of the user 58.

The file store 204 is defined by the application program 110 and the authentication resource 102 for storing an open file shown generally at 205. The open file 205 may include either a newly-created file, or may include the file 104 when loaded into memory.

In this embodiment, the file 104 stored on- the storage medium 100 includes a Microsoft Word 2002 document (.doc) file and accordingly, in this embodiment, the file 104 has contents including the text portion shown generally at 130, and has an object pool portion shown generally at 132 for storing various objects within the file 104. Such objects may include, for example, bitmap images, hyperlinks or other objects for example, defined by respective field object codes within the file 104. Each object in the object pool portion 132 has an associated storage stream, which in this embodiment is defined within an OCXDATA portion such as that shown generally at 134, for storing data associated with the object.

Similarly, therefore, in this embodiment, the open file 205 defined by the contents of the file store 204 includes a text portion 208 and an object pool portion shown generally at 210.

More particularly, in this embodiment, the authentication resource 102 directs the processor circuit 52 to define, in the object pool portion 210, a signature authentication object shown generally at 212. In this embodiment the signature authentication object has various operational modes, described in greater detail in the “Operation” section below.

In this embodiment, the signature authentication object 212 includes a plurality of fields for storing various information, including an encrypted hash value field 214, a digital certificate field 216, a public key field 218, a user name field 220, a voice byte stream field 222, a signature image field 224, a unique affirmation script field 226, a timestamp field 228, a remote time flag 230, a new hash value field 232 and a decrypted hash value field 234.

The encrypted hash value field 214 is used to store a validation value corresponding to contents of the file and the authentication voice sample, which has been encrypted using a private key.

The digital certificate field 216 is used to store a digital certificate issued to the user 58 including a public key required to decrypt messages such as the hash value encrypted using the digital certificate.

If a digital certificate is not used, a separate private key is used to encrypt the hash value and its corresponding public key is stored in the public key field 218 for use in decrypting the contents of the encrypted hash value field 214, and the user name field 220 is used to store a name of the user 58.

The voice byte stream field 222 is used to store the authentication voice sample as a byte stream of data.

The signature image field 224 is used to store a graphical representation of a signature of the user 58.

The unique affirmation script field 226 is used to store a unique affirmation script corresponding to the authentication voice sample, to indicate approval by the user 58 of contents of this particular file.

The timestamp field 228 is used to store a value representing the time and date at which the user 58 approved the file. The remote time flag 230 is used to store a bit to indicate whether the contents of the timestamp field 228 were obtained from a reliable source such as the remote time server 73, or from the local clock of the apparatus 50.

The new hash value field 232 is used to store a new hash value to be compared against a stored hash value to validate a previous signature containing an authentication voice sample.

The decrypted hash value field 234 is used to temporarily store the previously stored hash value for comparison to the contents of the new hash value field 232 to validate such a signature.

Similarly, in this embodiment, the signature generation object 206 includes a voice byte stream field 240, a remote time flag 242, a timestamp field 244, a hash value field 246, a digital certificate field 248, a public key field 252, a user name field 254, a signature image field 256, an encrypted hash value field 258, a unique affirmation script field 260 and a handles field 262. The hash value field 246 is used to store a hash value or digest value calculated over contents of the open file 205, and the handles field 262 is used to store a number of other handles, including handles indicating identities and locations of a cryptographic service provider (CSP), a hash object over which the hash value is to be calculated, and a private key associated with a digital certificate. Otherwise, the contents of the fields 240, 242, 244, 248, 252, 254, 256, 258 and 260 correspond respectively to the contents of the fields 222, 230, 228, 216, 218, 220, 224, 214 and 226 respectively.

In this embodiment the signature generation routine further directs the processor circuit to define a hash object register 270 in the RAM 200, for temporarily storing a hash object over which the hash value is to be calculated.

### OPERATION

### Signature Generation Routine

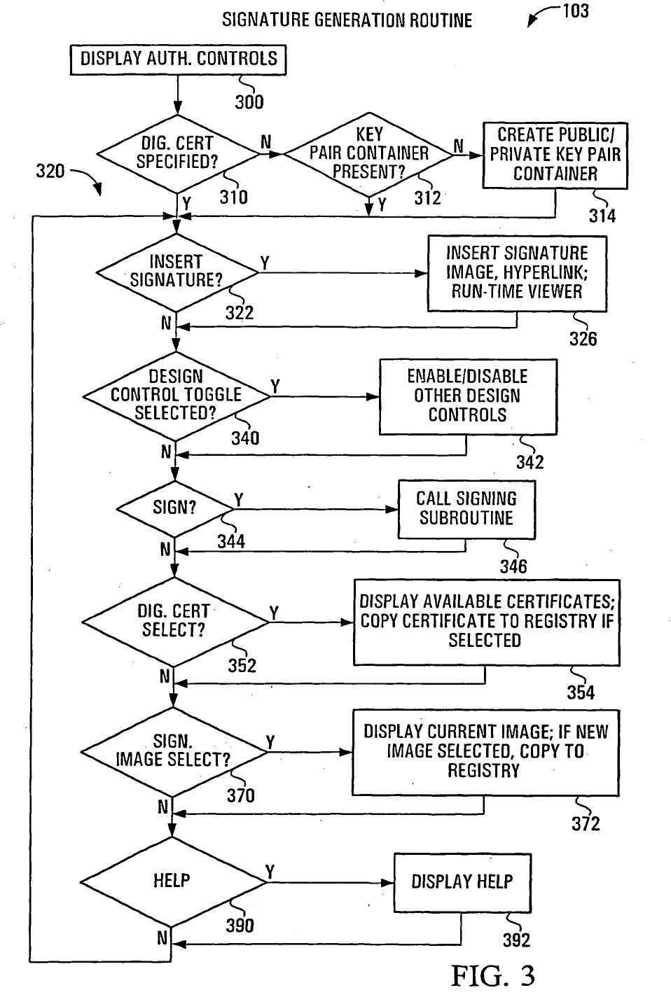

Referring to FIG. 3, the signature generation routine is shown generally at 103. As noted, in this embodiment, the authentication resource 102 is implemented as a dynamic link library (.dll) resource linked to the application program 110 so that the signature generation routine 103 of the authentication resource 102 is automatically executed whenever the application program 110 is executed.

Referring to FIGS. 2, 3 and 4, generally, in this embodiment, the signature generation routine 103 configures the processor circuit 52 to generate a public/private key pair for self-signing if necessary, and to respond to various signature generation and design-time commands associated with the authentication resource 102.

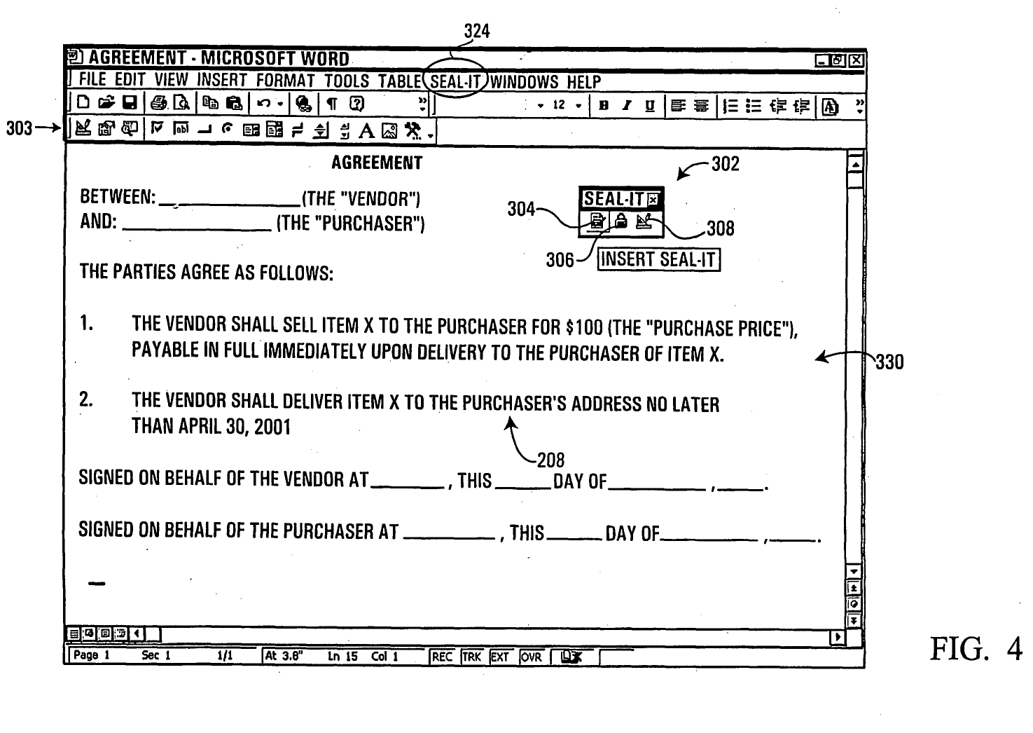

In this embodiment, the signature generation routine 103 commences with a first block of codes shown at 300 in FIG. 3, which directs the processor circuit 52 to display authentication controls shown generally at 302 in FIG. 4, and a plurality of design controls 303, which in this embodiment are implemented as ActiveX controls. More particularly, in this embodiment, the authentication controls 302 include a signature insertion control 304, a voice signing control 306 and a design mode control 308. The signature insertion and voice signing controls are discussed in greater detail below in connection with blocks 322 and 344, and the design mode control 308 is used to turn a design mode on or off by toggling a design mode control flag (not shown), to toggle availability of the design controls 303. In this embodiment the design controls 303 include a plurality of conventional design controls which may be used to modify a displayed representation of the signature authentication object 212, by adding such features as check-boxes, option buttons, command buttons, text boxes, list boxes, combination boxes, toggle buttons, spin buttons, scroll bars, labels and images for example, and to access any other analogous controls available on the apparatus 50, as well as to display properties and code associated with the displayed representation of the signature authentication object.

Block 310 then directs the processor circuit to determine whether a digital certificate has been previously specified by the user 58 of the apparatus 50, for the purpose of digitally signing documents containing authentication voice samples. More particularly, block 310 directs the processor circuit 52 to read the contents of the digital certificate file 118 in the registry area 116, to determine whether a digital certificate has been stored therein.

If no such digital certificate is located, block 312 directs the processor circuit 52 to determine whether a public/private key pair has been previously generated by the signature generation routine 103 for the purpose of signing files containing authentication voice samples. More particularly, block 312 directs the processor circuit 52 to determine whether the authentication public/private key pair container 124 exists.

If the authentication public/private key pair container 124 does not exist, block 314 directs the processor circuit 52 to create the authentication public/private key pair container 124 in the storage medium 100, containing a newly created private key and corresponding public key for encrypting and decrypting files. In this regard, in the present embodiment the authentication public/private key pair container 124 is created by the signature generation routine 103 to be application-specific, i.e., for the specific purpose of signing files containing authentication voice samples, so as not to conflict with any other public/private key pairs that may exist on the system 50, such as the default key pair that is used (and exposed) by the operating system 101, or other key pairs used by any other cryptographic applications on the system 50.

Following execution of block 314, or alternatively, if either a digital certificate or an authentication public/private key pair container was located at block 310 or block 312, the processor circuit 52 is directed to further blocks of codes shown generally at 320, which direct the processor circuit 52 to listen for user input indicating commands to which the signature generation routine 103 must respond.

In this regard, to achieve such listening, it will be recalled that in the present embodiment the authentication resource 102 is implemented as a .dll resource of the application program 110. Accordingly, in this embodiment the application program 110 includes a registry portion (not shown) including registry information associating various commands, such as menu items, buttons or other command targets for example, with respective resources. At the time of installation of the authentication resource 102, the registry portion of the application program 110 is modified to associate a plurality of such commands with the authentication resource 102, so that the authentication resource is registered as “owning” these commands. When the application program 110 receives a command that is registered to the authentication resource 102, the application program effectively passes an execution context to the signature generation routine 103, and control is passed to the signature generation routine 103 through a subroutine call. Thus, in the present embodiment, the blocks 320 of codes do not direct the processor circuit to actively poll for received command messages. Rather, the signature generation routine 103 passively awaits receipt of an execution context and subroutine call from the application program 110, in response to which the blocks 320 direct the processor circuit 52 to respond as indicated below. Alternatively, however, other suitable methods of listening for and responding to such commands may be substituted if desired.

Referring to FIGS. 3, 4 and 5, block 322 directs the processor circuit 52 to passively await receipt of a method call from the application program 110 indicating that an insert signature command has been received from the user 58. In this regard, the user may enter the insert signature command by actuating the signature insertion control 304 shown in FIG. 4, or alternatively, by selecting a corresponding command (not shown) on a drop down menu 324.

If at block 322 such a method call is received, block 326 directs the processor circuit 52 to define the signature authentication object 212 in the object pool portion 210 in the RAM 200, and to insert a signature image, which in this embodiment is a bitmap image, representing the signature of the user 58, into the signature authentication object 212. More particularly, block 326 directs the processor circuit 52 to copy the contents of the signature image file 120 stored in the registry area 116 to the signature image fields 224 and 256 respectively of the signature authentication object 212 and the signature generation object 206 in the RAM 200, if the signature image file 120 exists. Otherwise, block 326 directs the processor circuit to copy a default bitmap image stored within the authentication resource 102, such as a stylized image of “My Signature” for example, to the signature image fields 224 and 256.

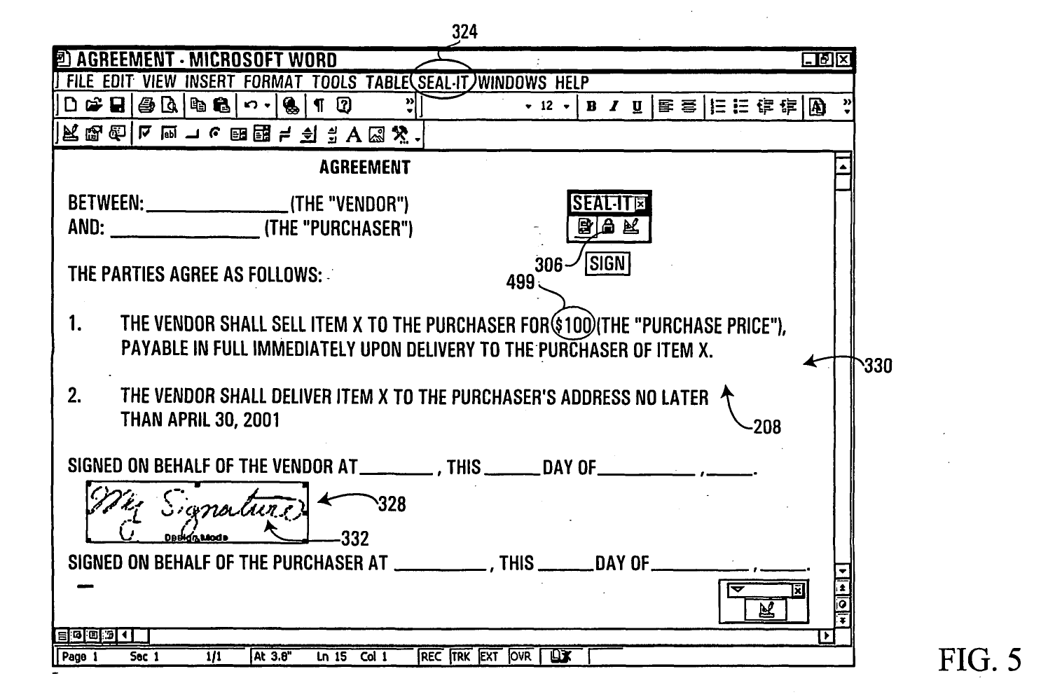

Block 326 further directs the processor circuit 52 to execute the signature authentication routine 107 which, among other functions, directs the processor circuit to continuously display a representation 328 of the signature authentication object 212 including a representation 332 of the user's signature in the display of the open file 205 shown in FIG. 5.

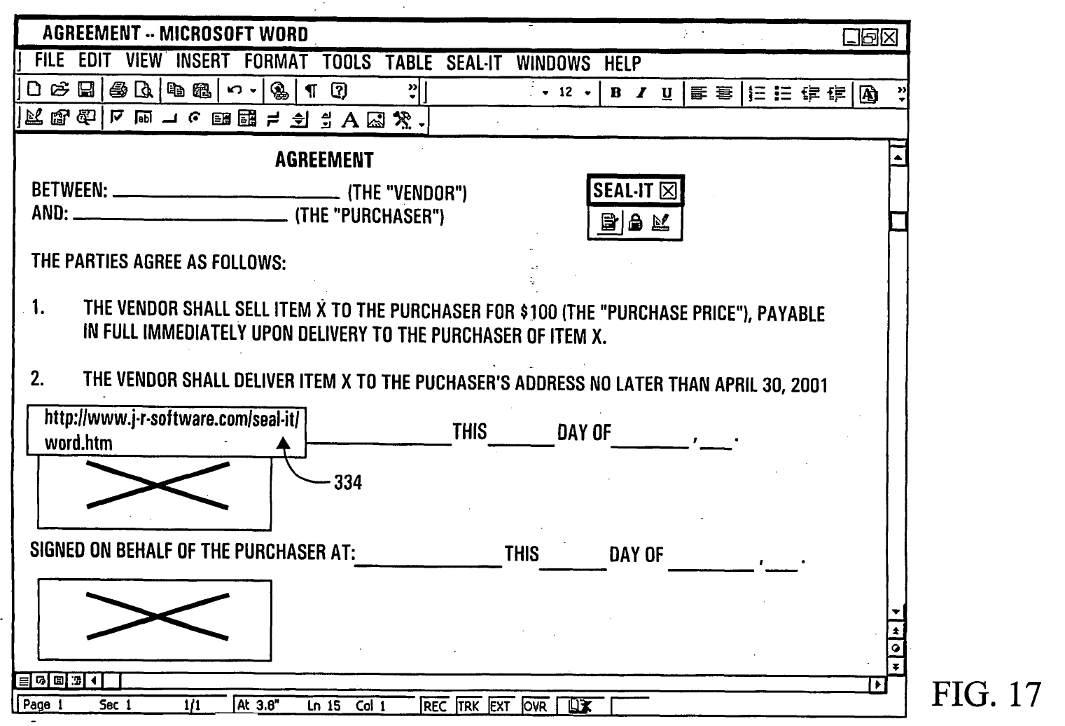

In addition, referring to FIGS. 2, 3 and 17, in this embodiment block 326 further directs the processor circuit 52 to store a hyperlink 334 in the file 205 in association with the signature authentication object 212. More particularly, in this embodiment, the hyperlink 334 includes a uniform resource locator (URL) of a location on the world wide web from which a version of a signature authentication viewer, such as the signature authentication routine 107 for example, capable of validating the signature authentication object 212 may be obtained. If desired, such a signature authentication routine may be freely distributed, to promote widespread use of the authentication resource 102.

Thus, if the open file 205 is subsequently saved as the file 104 and forwarded to a second user who does not have a signature authentication viewer capable of viewing and validating the signature authentication object 212, then such an other user may actuate the hyperlink 334 to download and install the signature authentication viewer.

Finally, block 326 also directs the processor circuit 52 to set the design mode flag (not shown) active to render the design controls 303 accessible.

Referring back to FIGS. 2, 3 and 4, following execution of block 326, or alternatively if an insert signature method call was not received at block 322, block 340 directs the processor circuit 52 to determine whether the design mode flag (not shown) has been toggled by actuation of the design mode control 308, and if so, block 340 directs the processor circuit 52 to permit use of any of the design controls shown generally at 303 in FIG. 4 if the flag is active, and to prevent use of any such design controls if the flag inactive. As noted, in-this embodiment, each of the design controls 303 is a conventional ActiveX control, for visually redesigning the features of the displayed representation 328 shown in FIG. 5 of the signature authentication object 212.

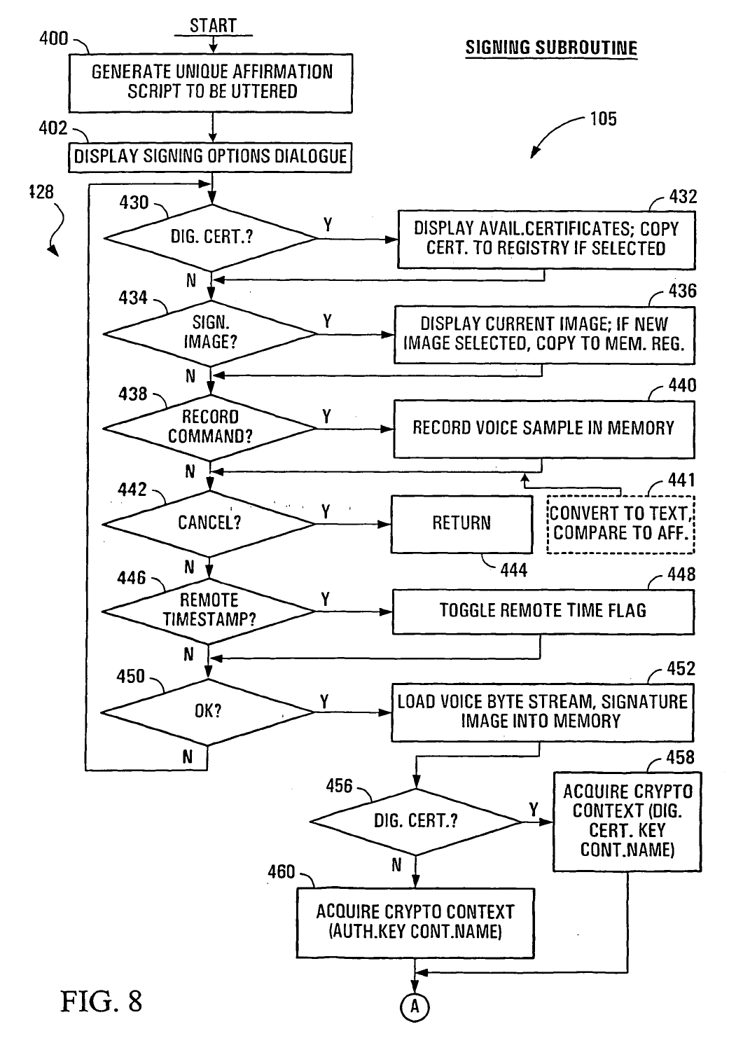

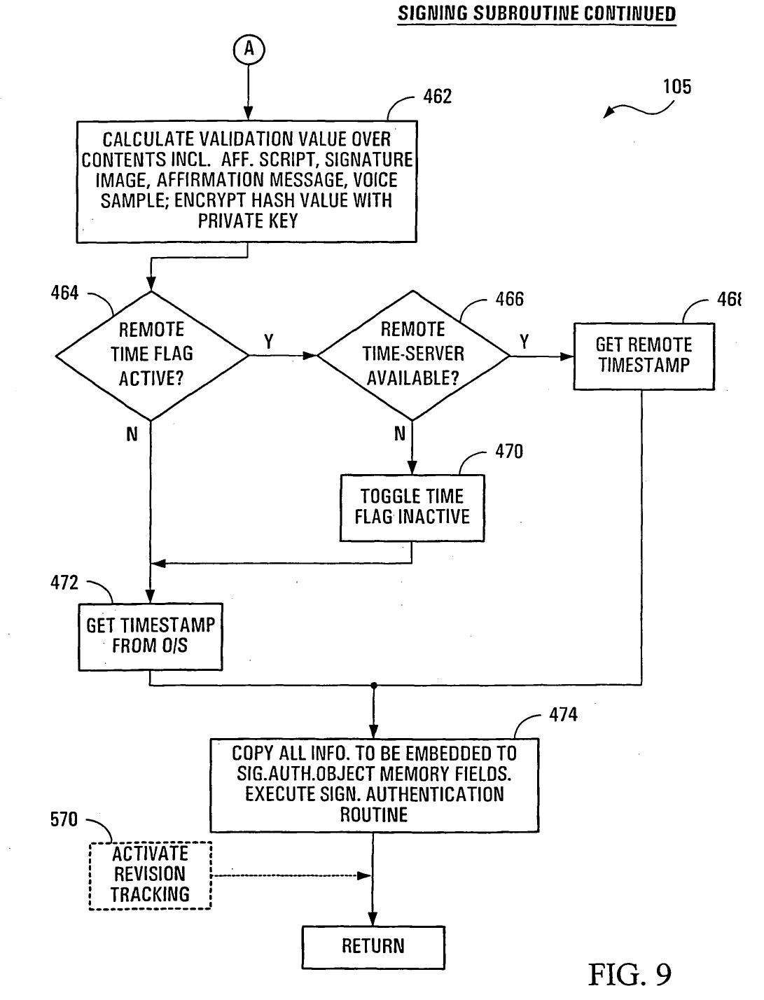

Referring to FIGS. 2, 3 and 5, following execution of block 340 or alternatively if no design mode control toggle command was received at block 340, block 344 directs the processor circuit to passively await receipt of a method call from the application program 110 indicating that a sign command has been entered by the user 58. In this regard, the sign command may be entered by the user by actuating the voice signing control 306 shown in FIG. 5 once the signature authentication object 212 has been inserted at block 326, or alternatively, the sign command may be selected from the drop down menu 324. In this embodiment, the sign command is used to associate an authentication voice sample with the open file 205 and to digitally sign the open file. If a method call indicative of a sign command is received, block 346 directs the processor circuit 52 to call the signing subroutine 105 shown in FIGS. 8 and 9.

Following such calling of the signing subroutine, or alternatively if no sign command was detected at block 344, block 352 directs the processor circuit 52 to passively await receipt of a method call from the application program 110 indicating that a digital certificate selection command has been received from the user 58. Such a command may be selected by the user 58 from the drop down menu 324, for example.

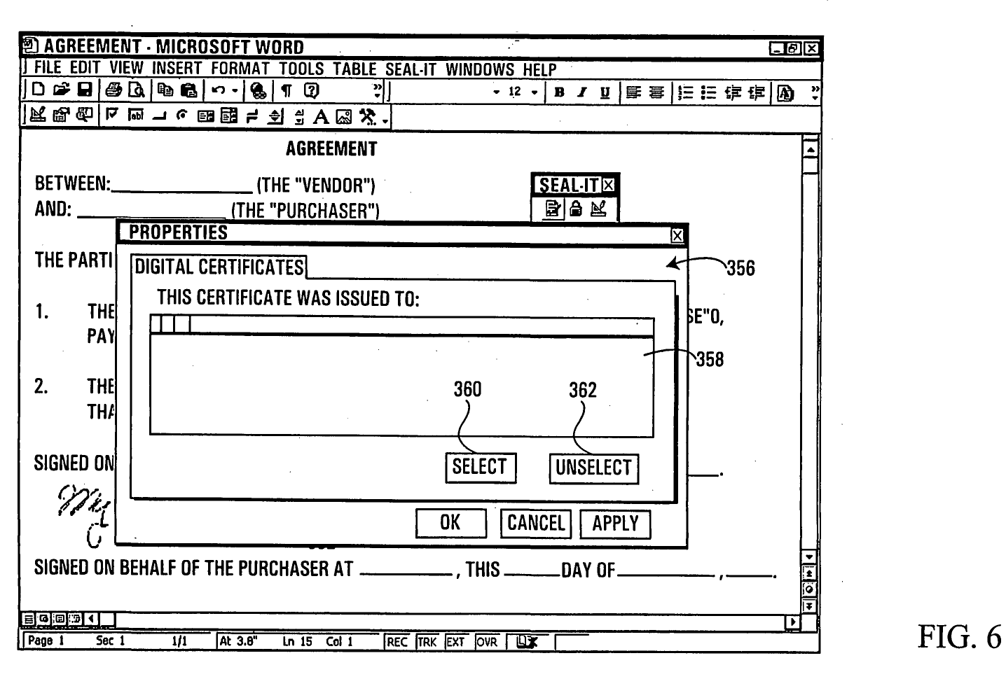

Referring to FIGS. 2, 3 and 6, if such a method call is detected, block 354 directs the processor circuit 52 to generate and display a digital certificates selection window such as that shown generally at 356 in FIG. 6. Block 354 further directs the processor circuit 52 to search the storage medium 100 for any digital certificate or certificates 122 stored therein. If any such certificates are located, block 354 directs the processor circuit to extract identifying information from the certificates and to display such information in a certificates area 358 of the digital certificates selection window 356. If any such certificates are displayed, the user may actuate either a selection button 360 to select such a digital certificate as the default certificate to be used in association with the authentication resource 102, in which case block 354 directs the processor circuit to copy the corresponding digital certificate to the registry area 116 as the digital certificate file 118, overwriting any preexisting digital certificate file in that registry area. Alternatively, if a particular digital certificate has already been selected in the above manner, the user may actuate an unselect button 362, in response to which block 354 directs the processor circuit to delete the digital certificate file 118 from the registry area 116. If the user closes the digital certificates selection window after deleting the digital certificate file 118 without selecting a new digital certificate, block 354 further directs the processor circuit to determine whether an authentication public/private key pair container has been created to be used instead of the digital certificate, and if not, to create one, as described above in connection with blocks 312 and 314.

Referring to FIGS. 2, 3 and 7, following execution of block 354, or alternatively, if a method call indicative of a digital certificate selection command was not received at block 352, block 370 directs the processor circuit 52 to passively await receipt of a method call from the application program 110 indicating that a signature image selection command has been received. Such a command may be entered by the user 58 by selection from the drop down menu 324 for example, however, in this embodiment the signature image selection command is only available in respect of an signature authentication object 212 that has already been defined in the RAM 200, at block 326 in the case of a new signature authentication object or at block 350 in the case of a previously-stored signature authentication object.

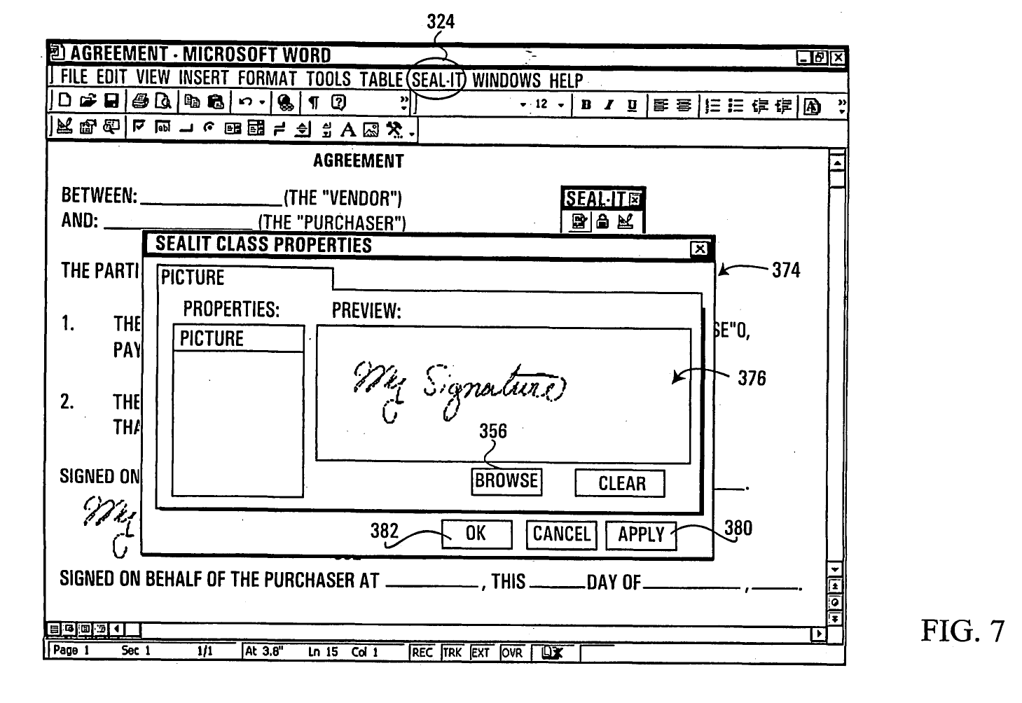

If such a method call is received, block 372 directs the processor circuit 52 to generate and display a signature image selection window shown generally at 374 in FIG. 7. Block 372 further directs the processor circuit 52 to access the bitmap image stored in the signature image field 224 in the signature authentication object 212 and to display this bitmap image in a preview frame 376 of the signature image selection window 374. The signature image selection window 374 further includes a browse button 378, an apply button 380 and an okay button 382. In response to actuation by the user 58 of the browse button 378, block 372 directs the processor circuit to display a file directory (not shown) of files stored in the storage medium 100. In response to selection of any such stored image, block 372 directs the processor circuit to temporarily display the selected image in the preview frame 376. In response to actuation of either the apply button 380 or the okay button 382, block 372 directs the processor circuit to copy the selected image to the signature image field 224 of the signature authentication object for immediate display by the signature authentication routine 107, to the signature image field 256 of the signature generation object 206 for subsequent inclusion in a hash object to produce a validation value, and to the signature image file 120 of the registry area 116, overwriting any existing signature image file stored therein, to act as the default signature image for the authentication resource 102.

In addition to the foregoing commands, a help command may be provided in the drop down menu 324 if desired, and accordingly, in the present embodiment, blocks 390 and 392 direct the processor circuit to passively await receipt of a method call from the application program 110 indicating that a help request has been received from the user 58 and if so, to display appropriate help contents.

In addition, if desired for convenience, the signature generation routine 103 may also be configured to listen for a right-click on the displayed representation 328 of the signature authentication object 212 while in design mode (i.e. when the design mode flag, not shown, has been set active), in response to which the signature generation routine may direct the processor circuit 52 to display a menu of convenient commands such as the voice signing command discussed above in connection with block 344, and a verification or validation command, discussed in further detail below in connection with the signature authentication routine 107.

The signature generation routine 103 continues to passively listen for and respond to commands as described above.

### Signing Subroutine

Referring to FIGS. 2, 3, 5, 8 and 9, the signing subroutine is shown generally at 105 in FIGS. 8 and 9. Generally, the signing subroutine 105 configures the processor circuit 52 to receive an authentication voice sample of a user (such as the user 58) of the open file 205, and to associate the authentication voice sample with the file to indicate approval by the user of contents of the file. More particularly, in this embodiment the signing subroutine directs the processor circuit 52 to associate with the open file, as the authentication voice sample, a unique utterance uttered by the user.

For example, as noted above, when the user 58 wishes to indicate approval of contents of the open file 205, such as the text portion shown generally at 208 in FIG. 5, the user 58 may invoke the signing subroutine to associate his or her authentication voice sample with the open file 205 to indicate such approval, by actuating the voice signing control 306 shown in FIG. 5.

Referring to FIGS. 2, 8, 9, 10 and 11, in this embodiment, the signing subroutine 105 begins with a first block 400 of codes which directs the processor circuit 52 to generate a unique affirmation script. It is reiterated that “script” in this sense includes words (or alternatively, other utterable entities) that are to be spoken by the user. To generate the unique affirmation script, block 400 directs the processor circuit to randomly select an entry in a lexicon. More particularly, in this embodiment block 400 directs the processor circuit to generate a random number and to use the number to address an entry location in the lexicon. To generate the random number, block 400 directs the processor circuit to invoke a random number generator, which in this embodiment is a Standard C Runtime Library Random Function Generator. In this regard, block 400 directs the processor to seed the random function generator to give the random function generator a variable initial reference value, by executing an SRAND command to seed the random function generator with a value representing the time of day obtained from the local system clock (not shown) of the apparatus 50, and directs the processor circuit to execute a RAND command to generate a random number between 1 and 30.

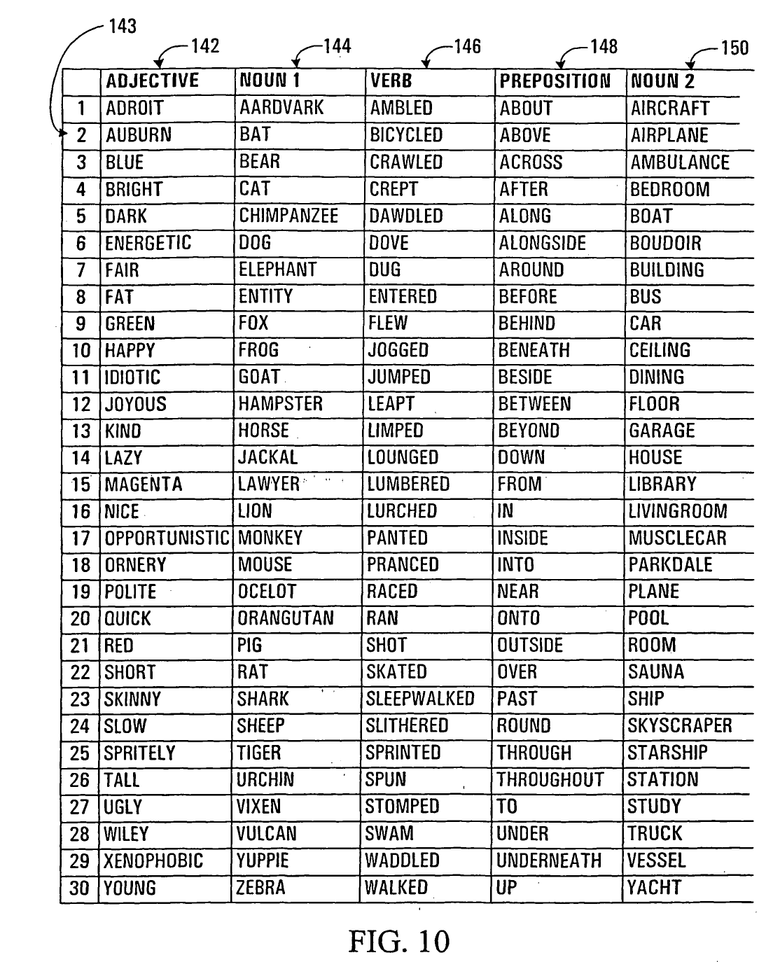

Referring to FIGS. 2, 3, 8 and 10, after generating such a random number, block 400 directs the processor circuit to randomly select an adjective from an adjective lexicon, by using the random number to address an entry location in the adjective lexicon 142 shown in FIG. 10, such as an entry location shown at 143 for example. Block 400 directs the processor circuit to copy the adjective stored in the addressed entry location to an adjective sub-field of the unique affirmation script field 260 in the RAM 200.

Similarly, block 400 then directs the processor circuit to successively invoke the random function generator to generate four further random numbers, and to use such random numbers to randomly select a first noun from the first noun lexicon 144, a verb from the verb lexicon 146, a preposition from the preposition lexicon 148, and a second noun from the second noun lexicon 150 shown in FIG. 10. Block 400 directs the processor circuit to store the randomly selected first noun, verb, preposition and second noun in respective first noun, verb, preposition and second noun sub-fields of the unique affirmation script field 260 in the RAM 200.

In this embodiment, block 400 further directs the processor circuit to store an article, or more particularly the word “the”, in a first article field preceding the adjective sub-field of the unique affirmation script field 260, and also in a second article field interposed between the preposition and second noun sub-fields of the unique affirmation script field.

Effectively, therefore, in this embodiment block 400 directs the processor circuit to generate the unique affirmation script by generating a random phrase, or more particularly a random sentence, by randomly selecting a plurality of words and assembling the words into the phrase. In this embodiment the random phrase stored in the unique affirmation script field is of the form “The {random adjective} {random first noun} {random verb} {random preposition} the {random second noun}”, such as “The skinny pig ran over the garage”, for example. Thus, in the present embodiment, there are 30×30×30×30×30=24,300,000 different random phrases. For all practical purposes, therefore, the random phrase generated by the processor circuit at block 400 is unique, and will be uniquely associated with the open file 205 and subsequently-stored corresponding file 104 to indicate approval by the user 58 of the contents of this particular file, as opposed to any other file.

Alternatively, however, other ways of generating this or other types of unique affirmation scripts or other unique utterances may be substituted.

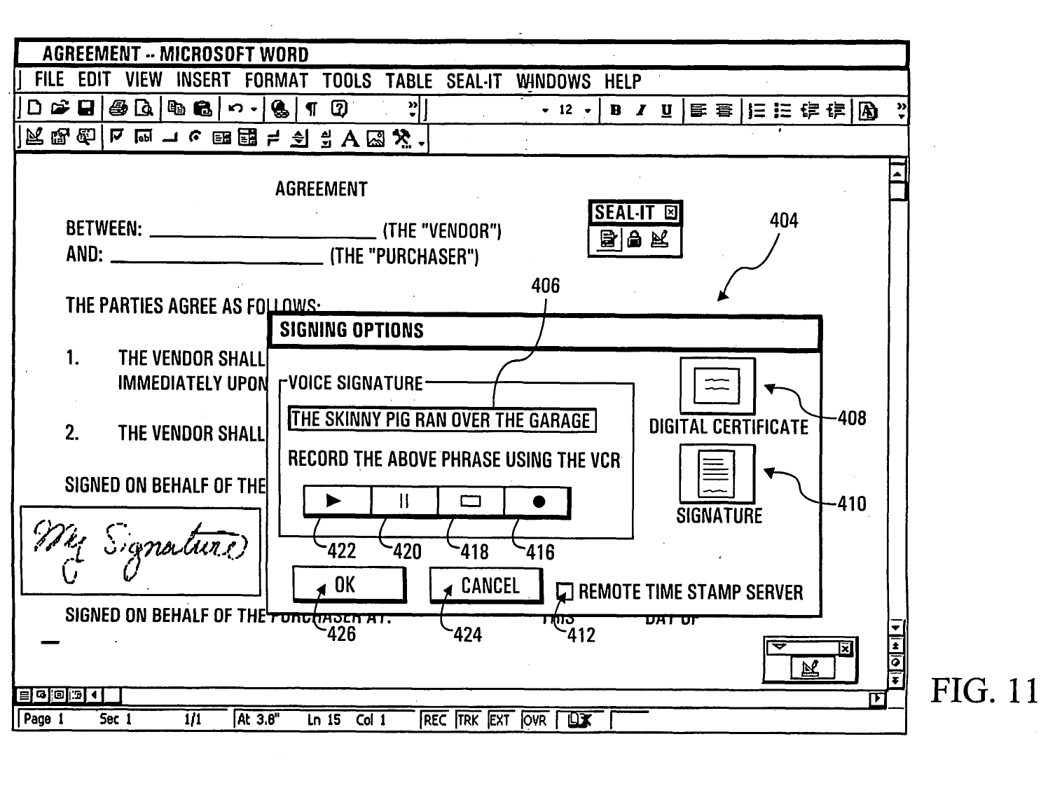

Referring to FIGS. 2, 3, 8 and 11, block 402 then directs the processor circuit to prompt the user 58 to utter, as the unique utterance, the unique affirmation script. More particularly, in this embodiment block 402 directs the processor circuit 52 to generate and display a signing options dialogue window such as that shown at 404 in FIG. 11. Block 402 directs the processor circuit to display the unique affirmation script stored in the unique affirmation script field 260 in a unique affirmation script field 406 of the signing options dialogue window 404. Block 402 further directs the processor circuit to display, within the signing options dialogue window 404, a plurality of command buttons, including a digital certificate selection command button 408, a signature image selection command button 410, a remote time server check box 412, and a plurality of record command buttons shown generally at 414 including a record button 416, a stop button 418, a pause button 420 and a playback button 422. Block 402 further directs the processor circuit to generate and display a cancel button 424 and an okay button 426 within the signing options dialogue window 404.

The processor circuit 52 is then directed to a plurality of blocks of codes shown generally at 428, which direct the processor circuit 52 to await receipt of signals indicating actuation of any of the command buttons within the signing options dialogue window 404.

Referring to FIGS. 2, 3, 6, 8 and 11, block 430 directs the processor circuit 52 to determine whether the digital certificate selection command button 408 has been actuated by the user 58, and if so, block 432 directs the processor circuit to generate and display the digital certificates selection window 356 shown in FIG. 6, for selection of a digital certificate as described above in connection with block 354 of the signature generation routine 103 shown in FIG. 3.

Similarly, referring to FIGS. 2, 3, 5, 7, 8 and 11, block 434 directs the processor circuit 52 to determine whether the signature image selection command button 410 has been actuated by the user 58, and if so, block 436 directs the processor circuit to generate and display the signature image selection window 374 shown in FIG. 7. As described above in connection with block 372 of the signature generation routine 103 shown in FIG. 3, if a new signature image is selected by the user, the selected signature image is copied to the signature image file 120 to act as the default signature image, to the signature image field 256 of the signature generation object for subsequent inclusion in a hash object, and to the signature image field 224 of the signature authentication object 212 for immediate display by the signature authentication routine 107 within the representation 328 of the signature authentication object 212 shown in FIG. 5.

Referring to FIGS. 2, 8 and 11, blocks 438 and 440 direct the processor circuit 52 to receive the authentication voice sample of the user 58 of the open file 205, or more particularly, to receive signals produced in response to an utterance by the user, and to store, as the authentication voice sample, data representing the signals. To achieve this, in this embodiment block 438 directs the processor circuit 52 to determine whether any of the record command buttons 414, such as the record button 416 for example, has been actuated by the user 58. If so, block 440 directs the processor circuit to execute the voice recorder application 112, which in this embodiment is a Windows Media Player, to respond to the selected record command. In this regard, it will be appreciated that the Windows Media Player is a Component Object Model (COM) object, as is the signature generation routine 103 in the present embodiment. Thus, the Windows Media Player includes a conventional COM interface including a plurality of function addresses (sometimes referred to as methods) which can be invoked or called by other applications or COM objects. More particularly, the Windows Media Player exposes an automation interface allowing clients such as the signature generation routine 103 to invoke play and record functionality. Accordingly, block 440 directs the processor circuit 52 to call a COM interface “Record” method exposed by the voice recorder application 112 to respond to the selected record command.

More particularly, if the record button 416 has been actuated, block 440 directs the processor circuit to invoke the voice recorder application 112 to direct the processor circuit 52 to receive, via the I/O interface 56, signals produced by the microphone 76 in response to an audible utterance made by the user 58, which in this embodiment is an utterance of the unique affirmation script displayed in the unique affirmation script field 406 of the signing options dialogue window 404. The voice recorder application directs the processor circuit 52 to store digital data representing the received signals in the authentication voice sample register 202 of the RAM 200. Similarly, in response to actuation of the stop button 418, block 440 directs the processor circuit 52 to signal the voice recorder application 112 to control the processor circuit to cease recording such digital data in the authentication voice sample register 202, and similarly, actuation and re-actuation of the pause button 420 directs the processor circuit 52 to cease and resume recording such digital data in the authentication voice sample register 202. Likewise, actuation of the playback button 422 directs the processor circuit 52 to signal the voice recorder application 112 to control the processor circuit 52 to control the amplified speakers 86 shown in FIG. 2, to generate an audible utterance corresponding to the contents of the authentication voice sample register 202.

Referring to FIGS. 2, 3, 8 and 11, block 442 directs the processor circuit 52 to determine whether the cancel button 424 has been actuated by the user 58, and if so, block 444 directs the processor circuit to return to the signature generation routine 103 shown in FIG. 3 to resume processing at block 348.

Block 446 directs the processor circuit 52 to determine whether the remote time server check box 412 has been actuated by the user 58, and if so, block 448 directs the processor circuit to toggle the contents of the remote time flag field 242, to set the flag active if the check box is checked and otherwise, to set the flag inactive. As discussed further below, this flag is used by the processor circuit to determine whether or not the time of the voice signature is to be obtained from the remote time server 73.

Block 450 directs the processor circuit to determine whether the okay button 426 has been actuated by the user 58 to indicate that a voice sample of the user uttering the unique affirmation script displayed in the affirmation script field 406, has been recorded.

If so, block 452 directs the processor circuit 52 to call a COM interface “Save” method exposed by the voice recorder application 112 to control the processor circuit to save the contents of the authentication voice sample register 202 to the storage medium 100, as a temporary authentication voice sample file 114, which in this embodiment is a .wav file. Block 452 then directs the processor circuit to generate and store a voice byte stream in response to the contents of the temporary authentication voice sample file 114, and to store the voice byte stream in the voice byte stream field 240. In this embodiment, the voice byte stream has the same binary format as the .wav file stored as the temporary authentication voice sample file 114.

Block 452 further directs the processor circuit to copy the contents of the signature image file 120 from the registry area 116 to the signature image field 256 in the RAM 200.

Block 456 then directs the processor circuit 52 to determine whether a digital certificate has been stored as the digital certificate file 118 as the registry area 116.

If so, block 458 directs the processor circuit 52 to copy the digital certificate to the digital certificate field 248, and to acquire a cryptographic context, for subsequent encryption using the private key corresponding to the public key stored in the digital certificate. In this regard, to locate and specify the corresponding private key, it will be appreciated that each digital certificate includes a key container name, which serves to identify, to a cryptographic engine of the operating system 101 of the system 50, a public/private key pair container stored on the system 50, which contains the particular public/private key pair corresponding to the digital certificate in question. In this embodiment, to enable use of the private key corresponding to the digital certificate for encryption, the key container name is passed to the cryptographic engine at the time the cryptographic context is acquired. More particularly, block 458 first directs the processor circuit 52 to extract the key container name from the digital certificate stored in the digital certificate field 248. Block 458 then directs the processor circuit 52 to acquire a cryptographic context, which in this embodiment is achieved by executing a CryptAcquireContext call including the key container name extracted from the digital certificate as a parameter of the call, to return the handle of a cryptographic service provider (CSP) of the operating system 101. In this embodiment the CSP is a Microsoft Base Cryptographic Provider, which creates digital signatures conforming to the RSA encryption standard. The handle of the CSP is then stored in the handles field 262. The CSP, having received the key container name corresponding to the digital certificate, will use the private key stored in the key container identified by the key container name, for subsequent encryption calls from the authentication resource 102.

Alternatively, if at block 456 no digital certificate file was found, block 460 directs the processor circuit to obtain a public key from the authentication public/private key pair container 124, and to acquire a cryptographic context, for subsequent encryption using the private key stored in the authentication public/private key pair container 124 (which was created at block 314 of the signature generation routine 103 shown in FIG. 3). More particularly, block 458 directs the processor circuit 52 to acquire a cryptographic context by executing a CryptAcquireContext call including the key container name of the authentication public/private key pair container 124 as a parameter of the call, to return the handle of a cryptographic service provider (CSP) of the operating system 101, which in this embodiment is, again, the Microsoft Base Cryptographic Provider. The handle of the CSP is then stored in the handles field 262. The CSP, having received the key container name corresponding to-the authentication public/private key pair container 124, will use the private key stored in the authentication public/private key pair container 124, for subsequent encryption calls from the authentication resource 102. Block 460 further directs the processor circuit to copy the public key from the key pair container 124 into the public key field 252, and also directs the processor circuit to obtain a user name or licensee name from a registry area (not shown) of the storage medium 100 corresponding to the application program 110, and to store the user name in the user name field 254.

Block 462 then directs the processor circuit 52 to store a validation value in association with the authentication voice sample. In this embodiment, block 462 directs the processor circuit to generate the validation value in response to contents of the open file 205. More particularly, in this embodiment, block 462 directs the processor circuit to generate the validation value by executing a hashing function to produce a digital digest as the validation value. Also in this embodiment, block 462 directs the processor circuit to generating the validation value in response to a unique affirmation script portion of the file, which in this embodiment is the contents of the unique affirmation script field 260. More particularly still, in this embodiment, block 462 directs the processor circuit to generate the validation value in response to contents of the text portion 208, as well as the contents of the unique affirmation script portion, a signature image portion, and an authentication voice sample portion of the file, which are included in the open file 205 upon execution of block 474 discussed below when the contents of the signature image field 256, the unique affirmation script field 260 and the voice byte stream field 240 are copied to the corresponding fields 224, 226 and 222. Alternatively, however, the validation value may be calculated over other contents or other permutations of contents of the file, including image contents, for example. However, in any such permutations, it is strongly desirable that the validation value be calculated at least over the unique affirmation script portion as well as whatever other content of the file is deemed to be necessary to protect the integrity of the file in the state or form in which the user has approved it. In this regard, if the unique affirmation script portion is not included in the hash object over which the hash value is calculated, then a sophisticated attacker would potentially be able to take a previous voice recording of the user, such as a previous authentication voice sample from a different file for example, and “sign” a new file by associating that previous recording with the new file, to forge the user's approval of the contents of the file. Although the unique affirmation script would not match the previous voice recording, the attacker would potentially be able to modify the contents of the unique affirmation script to match the words spoken by the user in the previous authentication voice sample, without affecting the hash value. In order to prevent this serious security threat, therefore, it is therefore strongly desirable to include the unique affirmation script portion in the hash object over which the validation value is calculated.

To generate the validation value, which in this embodiment is a digital digest or hash value, block 462 directs the processor circuit 52 to create a temporary hash object in the hash object register 270 of the RAM 200, by executing a CryptCreateHash command, and to return a handle to the hash object to the handles field 262. Block 462 then directs the processor circuit 52 to add data to the hash object, by successively executing a CryptHashData command four times, to successively add to the hash object the contents of the text portion 208 of the open file 205, the image of the signature of the user 58 stored in the signature image field 256, the authentication voice sample which in this embodiment is an utterance of the unique affirmation script by the user 58 stored in the voice byte stream field 240, and the unique affirmation script itself stored in the unique affirmation script field 260. Block 462 then directs the processor circuit to calculate a cryptographic hash value over the contents of the hash object register 270, and to encrypt the resulting hash value with the private key which has previously been identified to the CSP at the time the cryptographic context was acquired (at block 458 or block 460, above). More particularly, in this embodiment, block 462 directs the processor circuit to calculate and encrypt the hash value by executing a CryptSignHash command, to calculate a cryptographic hash value over the contents of the hash object register 270 using the hashing algorithm 109, which in this embodiment is an MD5 hashing algorithm, and to encrypt the resulting hash value in accordance with the RSA encryption standard, using the private key previously identified to the CSP at the time the cryptographic context was acquired (block 458 or block 460). Alternatively, any other suitable hashing algorithm, such as an SHA1 algorithm for example, may be substituted. Block 462 directs the processor circuit to store the resulting hash value in the hash value field 246, and to store the encrypted hash value in the encrypted hash value field 258. Thus, in this embodiment, storing the validation value involves encrypting the validation value to produce an encrypted validation value. In addition, it will be appreciated from the foregoing that in the present embodiment, the validation value is generated in response to contents of the open file 205 excluding authentication objects that include authentication voice samples other than the authentication voice sample stored in the voice byte stream field 240. This is advantageous as it permits a user to counter-sign the file by inserting a subsequent signature authentication object 212 into the file without invalidating a previously inserted analogous signature authentication object of another user or of the same user, as will be discussed in greater detail below in connection with the signature authentication routine.

Block 464 then directs the processor circuit 52 to determine whether the bit stored in the remote time flag field 242 has been set active to indicate that a timestamp is to be obtained from the remote time server 73.

If so block 466 directs the processor circuit 52 to attempt to communicate with the remote time server 73 via the I/O interface 56 and the network 70 by attempting to access a remote time server URL identified within the authentication resource 102. If the remote time server is available, block 468 directs the processor circuit to retrieve a remote timestamp from the remote time server and to store the timestamp in the timestamp field 244. The processor circuit is then directed to block 474 discussed below.

If on the other hand, the remote time server 73 was not available at block 466, block 470 directs the processor circuit to set the bit stored in the remote time flag field 242 inactive to indicate a remote timestamp was not obtained.

Following execution of block 470, or alternatively if the remote time flag was not active at block 464, block 472 directs the processor circuit 52 to obtain a local timestamp from the local system clock (not shown) of the apparatus 50 and to store the timestamp in the timestamp field 244.

Following execution of block 472 or block 468, block 474 then directs the processor circuit 52 to store the authentication voice sample in association with the open file 205. More particularly, in this embodiment, the sample is stored in the open file 205 itself. To achieve this, block 474 directs the processor circuit to copy the contents of the voice byte stream field 240 to the voice byte stream field 222 of the signature authentication object 212 in the object pool portion 210 of the file. Block 474 further directs the processor circuit to copy the contents of the remote time flag field 242, the timestamp field 244, the digital certificate field 248, the public key field 252, the user name field 254, the signature image field 256, the encrypted hash value field 258 and the unique affirmation script field 260 to their corresponding fields 230, 228, 216, 218, 220, 224, 214 and 226 of the signature authentication object 212 in the object pool portion 210 of the file. Thus, in this embodiment storing the authentication voice sample involves storing the sample in association with an object, i.e. the signature authentication object 212, in the file and thus involves storing the sample in association with a representation of a signature, i.e. the signature image field 224, of the user 58, and also in association with a timestamp stored in the timestamp field 228.

In this embodiment, block 474 further directs the processor circuit 52 to commence execution of the signature authentication routine 107 to await receipt of a save command from the user 58. Following execution of block 474, the processor circuit is directed to return to the signature generation routine 103 shown in FIG. 3, to resume processing at block 348.

### Signature Authentication Object Operational Modes

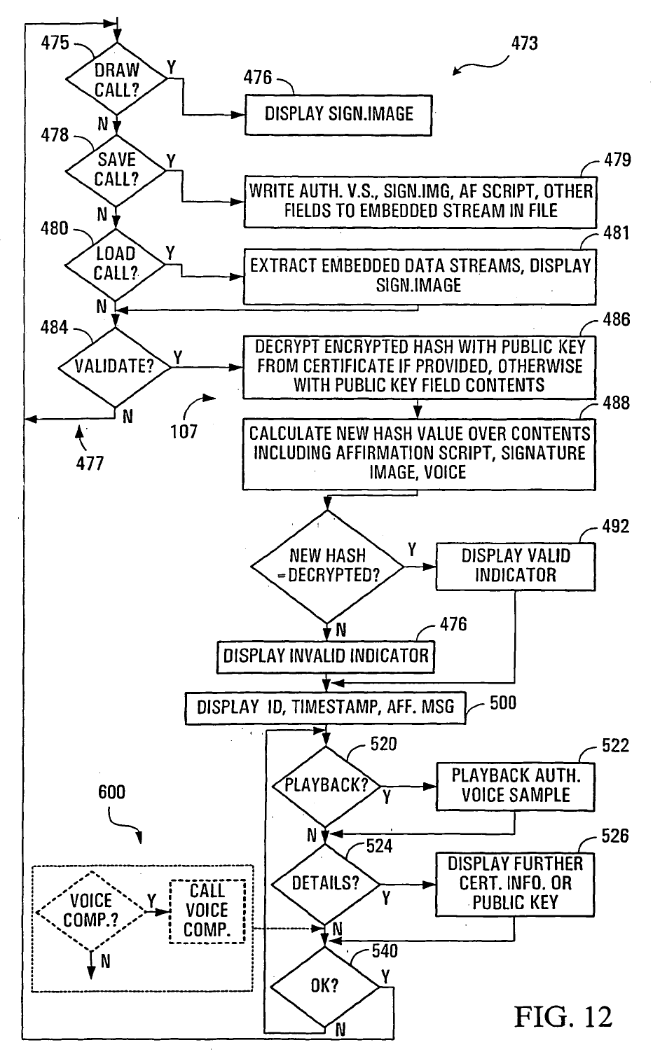

Referring to FIGS. 2 and 12, various operational modes of the signature authentication object 212 are shown generally at 473 in FIG. 12. Generally, in this embodiment, the signature authentication object operational modes configure the processor circuit 52 to store the authentication voice sample and other associated information in the file 104 in the storage medium 100, to load such information from a newly-opened existing file, and to draw a signature image of an open file. In this embodiment, the signature authentication operational modes also configure the processor circuit to receive the authentication voice sample, of the user of the file, associated with the file to indicate approval by the user of contents of the file, and to validate the authentication voice sample.

Referring to FIGS. 2 and 12, in this embodiment the signature authentication object operational modes 473 include further blocks of codes shown generally at 477, which direct the processor circuit 52 to passively await receipt of method calls from the application program 110 indicating that the user 58 has actuated either a “save” command to save the open file 205 to the storage medium 100 as the file 104, a “load” command to open an existing file, a “draw” call to re-draw the image of the user's signature, or alternatively a “validate” command to validate an authentication voice sample associated with the open file 205.

In the present embodiment such waiting involves passive waiting rather than active polling. In this regard, the signature authentication object in the present embodiment is implemented as an ActiveX control, and as such, it is required to expose a COM interface, or more particularly, an IPersistStream interface including a “Save” method and a “Load” method. When the application program 110 receives a save command from the user indicating that the open file 205 is to be saved as the file 104, it calls the Save method of all COM objects associated with the open file 205, including the Save method exposed by the signature authentication object 212. More particularly, when the application program 110 calls the Save method of the signature authentication object 212, the application program passes a parameter to the signature authentication object 212, identifying a storage stream, which in this embodiment is the OCXDATA portion 134, into which the signature authentication object is permitted to save data. In this regard, the signature authentication object is permitted to save such data in any format, proprietary or otherwise, as the application program will subsequently rely on the ActiveX control associated with the signature authentication object to load the OCXDATA stream, rather than attempting to directly access such data.

Similarly, when the application program 110 opens an existing file containing an object registered to the authentication resource 102, the application program calls the “load” method of the signature authentication object 212, the method call including a parameter identifying of the location of the OCXDATA portion in the opened file 205 in which the signature authentication object 212 is directed to locate its data.

Likewise, the application program 110 will periodically call the “draw” method of the signature authentication object 212, to request the signature authentication object to re-draw the signature image, for example, because a user has scrolled to a shifted screen position.

### Draw

Thus, in this embodiment, block 475 of the signature authentication operational modes 473 generally directs the processor circuit 52 to passively await receipt of a “draw” method call from the application program 110, and upon receipt of such a draw method call, block 476 directs the processor circuit to display, in the display of the open file 205 shown in FIG. 5, the representation 328 of the signature authentication object 212 including the representation 332 of the user's signature, or more particularly the signature image stored in the signature image field 224 of the signature authentication object 212. Effectively, therefore, the signature image is continuously displayed.

### Save

Referring to FIGS. 2, 5 and 12, following execution of block 476 to draw the signature image, or alternatively, if no “draw” method call was received at block 475, block 478 of the signature authentication operational modes 473 directs the processor circuit 52 to passively await receipt of a Save method call from the application program 110 including a parameter identifying the OCXDATA portion 134, indicating that the user 58 has actuated a “save” command of the application program 110, in order to save the file 205 to the storage medium 100 as the file 104.

Upon detecting such a Save method call, block 479 directs the processor circuit 52 to store the authentication voice sample in association with the file 104, or more particularly in the file 104. In this embodiment, this is achieved by directing the processor circuit 52 to copy the contents of the voice byte stream field 222 into the OCXDATA portion 134 associated with the signature authentication object 212. More particularly still, in this embodiment, block 479 directs the processor circuit to insert the voice byte stream field 222 contents into the OCXDATA portion 134 as a BSTR string. In this regard, the BSTR string is a length-delimited string, the first four bytes of which include an indication of the length of the string. Accordingly, block 479 directs the processor circuit to store an indication of the length of the voice byte stream field 222 in the first four bytes of the BSTR string, and to store the voice byte stream field itself immediately following the first four bytes.

Thus, in this embodiment, the authentication voice sample is stored in an embedded stream in the file 104. More particularly, in this embodiment the embedded stream is the BSTR string containing the authentication voice sample 106, stored in the OCXDATA portion 134 of the object pool portion 132 of the file 104.

Similarly, block 479 directs the processor circuit 52 to store the validation value in association with the authentication voice sample, which in this embodiment is achieved by directing the processor circuit to copy the contents of the encrypted hash value field 214 into a further BSTR string in the OCXDATA portion 134 of the file 104. Thus, the encrypted validation value is stored in association with the authentication voice sample. Likewise, block 479 also directs the processor circuit to store a representation of a signature of the user 58 and a timestamp in association with the authentication voice sample, which in this embodiment is achieved by copying the contents of the signature image field 224 and the timestamp field 228, as well as the remote time flag, to respective corresponding BSTR strings in the OCXDATA portion 134. Likewise, block 479 directs the processor circuit 52 to copy the contents of the digital certificate field 216, the public key field 218, the user name field 220 and the unique affirmation script field 226 to respective corresponding BSTR strings in the OCXDATA portion 134. Thus, in this embodiment, a plurality of embedded streams are stored in the storage stream, i.e. the OCXDATA portion 134, to enable subsequent authentication or validation of the user's authentication voice sample. The purposes of such streams have been described above, and may be summarized as follows. The encrypted hash value byte stream is used to validate the authentication voice sample stored in the voice byte stream, to confirm that changes have not been made to approved contents of the file subsequent to the association of a user's authentication voice sample with the file to indicate that user's approval of the approved contents of the file. The digital certificate byte stream may be used to provide a public key to decrypt the encrypted hash value, and to provide further information confirming the identity of the user whose authentication voice sample has been associated with the file. Alternatively, if a digital certificate byte stream is not present, the public key byte stream may be used to decrypt the encrypted hash value, and the username byte stream provides a username of the user whose corresponding private key was used to encrypt the hash value. The signature image byte stream is used to store an image of a signature of the user, and the unique affirmation script byte stream is used to store a textual representation of a unique affirmation script, which in this embodiment represents meaningful speech corresponding to the authentication voice sample stored in the voice byte stream. The timestamp byte stream is used to provide a timestamp indicating the time and date at which the user's authentication voice sample was associated with the file to indicate the user's approval of its contents, and the remote time flag byte stream is used to store a bit indicating whether the timestamp was obtained from a reliable remote time server such as the remote time server 73 or whether it was simply obtained from the user's local clock.

The application program 110 then proceeds to save the remainder of the file 205 as the file 104 in the usual manner, and therefore stores the text portion 208 as the text portion 130, and also copies the hyperlink 334 into the file 104 in association with the signature authentication object 212 defined by the contents of the OCXDATA portion 134. Thus, as the OCXDATA portion 134 contains the authentication voice sample as an embedded stream therein, the hyperlink is stored in association with the authentication voice sample.

### Load

Referring to FIGS. 2, 5 and 12, following execution of block 479 to store the authentication voice sample 106 in association with the file 104, or alternatively, if no method call indicating a save command was received at block 478, block 480 directs the processor circuit 52 to passively await receipt of a “Load” method call from the application program 110 indicating that an existing file, such as the file 104 for example, whose object pool portion 132 includes data (which in this embodiment is included in the OCXDATA portion 134) defining an authentication object, has been opened by the application program 110 and stored as an open file 205 in a file store 204 in the RAM 200. (It will be appreciated that for most applications, more than one file store 204 corresponding to more than one respective open file 205, each containing a respective signature authentication object, may be defined in the RAM 200 at any given time. Similarly, it will be appreciated that upon opening any file containing a file containing a signature authentication object associated with the authentication resource 102, will automatically instantiate the signature authentication object 212 in the RAM 200, and will then call the load method of the object 212.)

If so, block 481 directs the processor circuit 52 to define a signature authentication object 212 in the object pool portion 210 in the newly-opened file 205, and to copy the contents of a plurality of embedded BSTR byte streams from the OCXDATA portion of the open file 205 to a plurality of respective corresponding fields of the signature authentication object 212. More particularly, in this embodiment block 481 directs the processor circuit to copy the contents of an encrypted hash value byte stream, a digital certificate byte stream (if present), a public key byte stream (if present), a username byte stream (if present), a voice byte stream, a signature image byte stream, a unique affirmation script byte stream, a timestamp byte stream, and a remote time flag byte stream, to their respective corresponding fields 214, 216, 218, 220, 222, 224, 226, 228 and 230 in the signature authentication object 212.

Block 481 further directs the processor circuit to display the representation 328 of the signature authentication object 212 including the representation 332 of the signature image now stored in the signature image field 224 of the signature authentication object 212.

### Validate

Referring to FIGS. 2, 5 and 12, following execution of block 479 to store the authentication voice sample 106 in association with the file 104, or alternatively, if no method call indicating a save command was received at block 478, block 484 directs the processor circuit 52 to passively await receipt of a “Validate” method call from the application program 110. In this embodiment, a Validate command may be entered by the user 58 by clicking on the representation 328 of the signature authentication object 212 when the object is not in design mode, or alternatively, by right-clicking on the representation 328 when the signature authentication object 212 is in design mode and selecting a verify signature command on a resulting menu (not shown) generated by the signature generation routine 103 in response to such a right-click. Alternatively, the validate command may be selected from the drop down menu 324 if a displayed representation 328 of a signature authentication object has been selected. In either case, the application program 110 directs the processor circuit to consult a mapping portion of the application program to identify the resource associated with the received command. Upon identifying the signature authentication object 212 as the associated resource, the application program calls a “Validate” method of the COM interface exposed by the signature authentication object 212.

If at block 484 a “Validate” method call is received by the signature authentication object 212, the processor circuit 52 is directed by the operational modes 473 to execute the signature authentication routine, shown generally at 107 in FIG. 12.

Upon execution of the signature authentication routine 107, blocks 486 through 496 direct the processor circuit 52 to receive the authentication voice sample, of the user of the open file 205, which has been associated with the file to indicate approval by the user of contents of the file, and to validate the authentication voice sample.

To achieve such validation, in this embodiment, block 486 first directs the processor circuit 52 to decrypt an encrypted stored validation value to extract a stored validation value. In this regard, block 486 directs the processor circuit to read the contents of the encrypted hash field 214, the digital certificate field 216 and the public key field 218 of the signature authentication object 212 in respect of which validation has been requested. It will be recalled that the contents of the various fields of the signature authentication object 212 are either inserted into the signature authentication object 212 by execution of the signing subroutine 105 shown in FIGS. 8 and 9 in the case of a new signature authentication object, or alternatively, are loaded into the signature authentication object 212 upon execution of block 350 of the signature generation routine 103 in the case of a previously saved signature authentication object in a previously saved file 104 at the time such file is loaded into memory as the open file 205. Accordingly, if the encrypted hash field is empty, block 486 directs the processor circuit 52 to generate and display an error message indicating that no authentication voice sample has been associated with this particular object, or in other words, that the signing subroutine 105 has never been executed in relation to the object.

Otherwise, if the encrypted hash field 214 contains data, block 486 directs the processor circuit 52 to determine whether the digital certificate field 216 contains data representing a digital certificate used to encrypt the encrypted hash value. If such data is present in the digital certificate field 216, block 486 directs the processor circuit to extract a public key from the contents of the digital certificate field 216, and to use the public key to decrypt the contents of the encrypted hash value field 214 in accordance with the RSA encryption standard, and to store the resulting decrypted hash value in the decrypted hash value field 234. Otherwise, if the digital certificate field 216 contains no data, block 486 directs the processor circuit to use a public key stored in the public key field 218 to decrypt the contents of the encrypted hash value field 214 and to store the resulting decrypted hash value in the decrypted hash value field 234.

Block 488 then directs the processor circuit 52 to generate a validation value in response to contents of the open file 205 and to compare the validation value to a stored validation value, or more particularly to the decrypted hash value, associated with the authentication voice sample. In this embodiment, block 488 achieves this by first directing the processor circuit to generate the validation value by executing a hashing function to produce a digital digest value as the validation value. Also in this embodiment, block 488 directs the processor circuit to generate the validation value in response to a unique affirmation script portion of the open file 205. More particularly, in this embodiment, the processor circuit is directed to generate the validation value in response to the text portion 208, as well as a signature image portion, the unique affirmation script portion and an authentication voice sample portion of the open file 205. In this embodiment, the signature image portion is the contents of the signature image field 224, the unique affirmation script portion is the contents of the unique affirmation script field 226, and the authentication voice sample portion is the contents of the voice byte stream field 222. To achieve this, block 488 directs the processor circuit to first acquire a cryptographic context and create a hash object in the hash object register 270, as described above in connection with block 462 of the signing subroutine 105. Block 488 then directs the processor circuit to successively add the contents of the text portion 208, the unique affirmation script field 226, the signature image field 224 and the voice byte stream field 222 to the newly created hash object stored in the hash object register 270, also in a manner similar to that described above in connection with block 462. Finally, block 488 directs the processor circuit to apply the hashing algorithm 109, which in this embodiment is the MD5 hashing algorithm, to the contents of the hash object register 270, to produce a new hash value, i.e. a digital digest, which the processor circuit is directed to store in the new hash value field 232. Alternatively, as noted, any other suitable hashing algorithms, such as SHA1 for example, may be used by the signature generation routine and the signature authentication routine if desired.

Blocks 490, 492 and 496 then configure the processor circuit 52 to indicate invalidity of the authentication voice sample if approved contents of the file have changed subsequent to association of the authentication voice sample with the file to approve the approved contents.

To achieve this, blocks 490, 492 and 496 direct the processor circuit 52 to indicate validity of the authentication voice sample if the validation value matches the stored validation value, and to otherwise indicate invalidity of the authentication voice sample. More particularly, block 490 directs the processor circuit to compare the new hash value stored in the new hash value field 232 to the decrypted hash value stored in the decrypted hash value field 234.

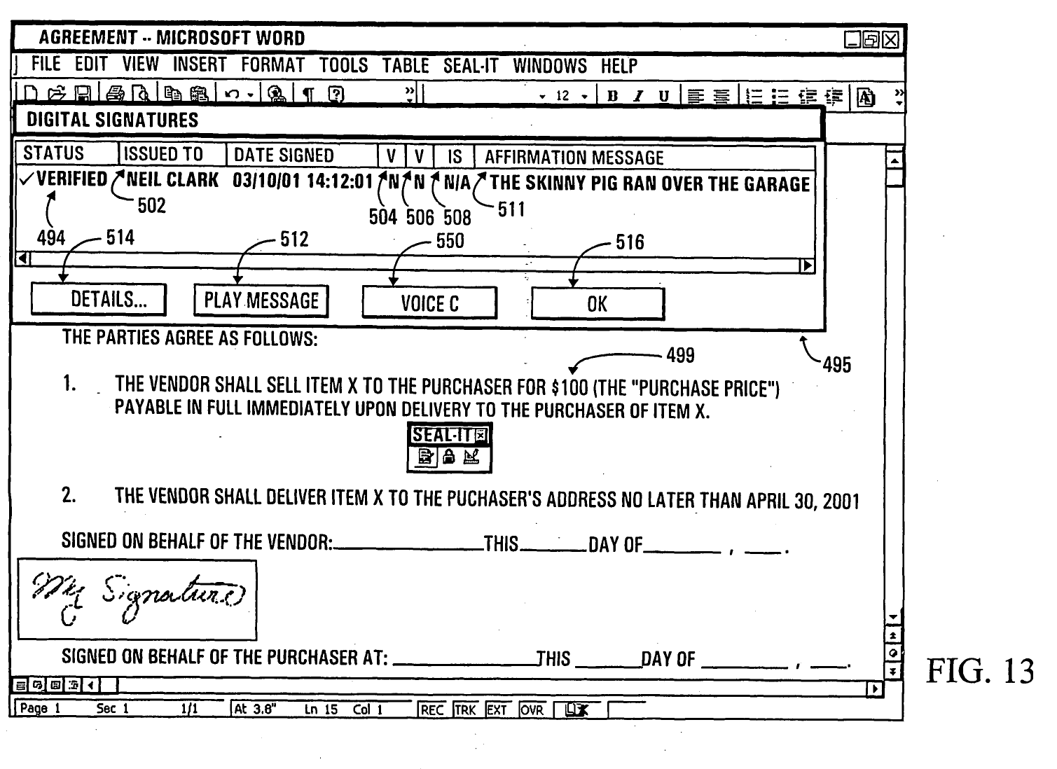

Referring to FIGS. 2, 12 and 13, if at block 490 the contents of the new and decrypted hash value fields 232 and 234 are identical, block 492 directs the processor circuit 52 to display a validity indication such as that shown generally at 494 in FIG. 13, to indicate that the authentication voice sample is valid, or in other words, that the approved contents of the file which the user approved by associating the authentication voice sample with the file, have not changed since the voice sample was associated with the file. In this embodiment, the validity indication 494 is displayed within a digital signatures dialogue window 495.

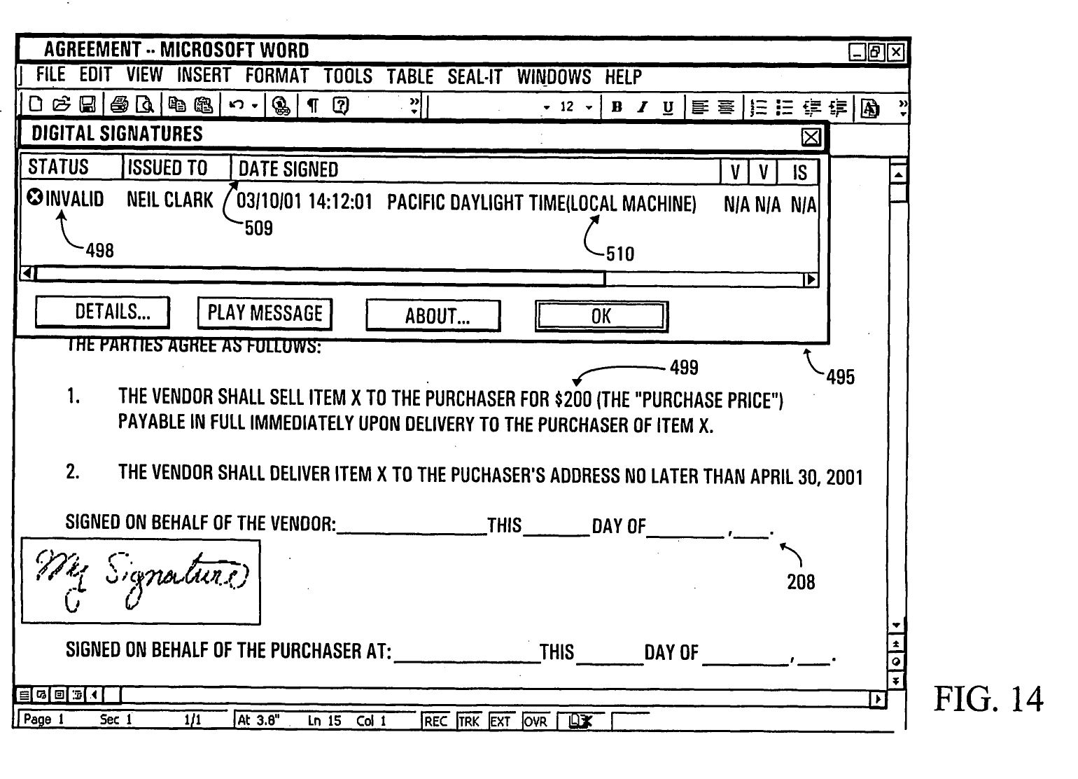

Conversely, referring to FIGS. 2, 12 and 14, if at block 490 the contents of the new hash value field 232 and the decrypted hash value 234 are not identical, block 496 directs the processor circuit 52 to display an invalidity indication, such as that shown at 498 in FIG. 14, to indicate that the authentication voice sample is invalid, or in other words, that the approved Contents of the file, which the user approved by associating the authentication voice sample with the file, have changed since the user approved the contents of the file in this manner. In this embodiment, the invalidity indication 498 is also displayed within the digital signatures dialogue window 495.

Thus, for example, referring to FIGS. 5, 13, 14 and 16, if any of the contents of the file over which the hash value is calculated, such as a text string portion 499 of the text portion 208 of the file for example, have been changed subsequent to the association of the user's authentication voice sample with the file, any such change results in a different new hash value calculated at block 488 which does not equal the decrypted hash value, and accordingly, in response to a validate command from any user of the file, the invalidity indication 498 shown in FIG. 14 will be displayed. However, if all such subsequent changes are undone by restoring the text to its original contents, i.e. to the same contents which the user approved by associating his or her authentication voice sample with the file, then the new hash value calculated at block 488 will once again equal the decrypted hash value, and the validity indication 494 shown in FIG. 13 will be displayed in response to a validate command.

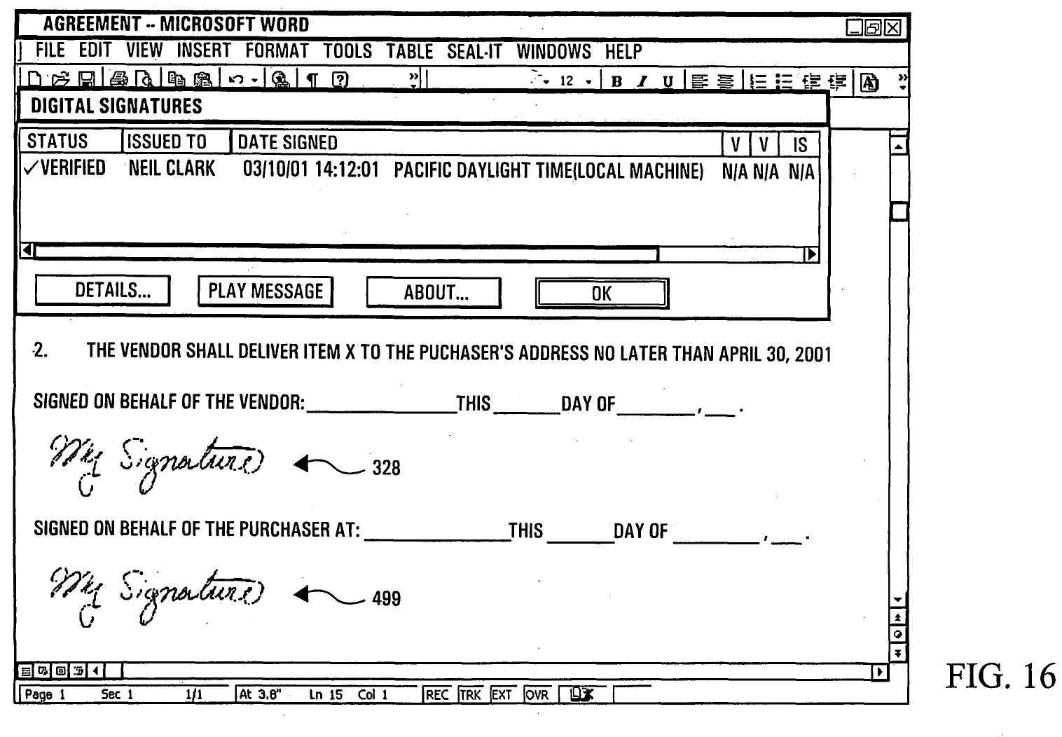

Conversely, however, it will be appreciated that due to the execution of block 488 as described above, in this embodiment, the validation value is generated in response to contents of the file excluding authentication objects that include authentication voice samples other than the authentication voice sample stored in the voice byte stream field 222. For example, if, after a first user has approved the contents of the file by associating that user's authentication voice sample with the file and generating the signature authentication object 212, a second user counter-signs or approves the contents of the file by generating a second signature authentication object in the object pool portion 210, a representation of which is shown at 499 in FIG. 16 for example, then the contents of the second signature authentication object do not form part of the hash object created at block 488 to validate the first user's authentication voice sample. Accordingly, the new hash value generated at block 488 to validate the first user's authentication voice sample will not be affected by the insertion of the second user's authentication voice sample, and the first user's authentication voice sample will thus remain valid (provided no other changes to the contents of the file have occurred). Accordingly, if desired, other users may counter-sign the file by inserting additional signature authentication objects containing additional respective authentication voice samples into the file 205, either before or after it is permanently stored as the file 104, without affecting the validity of any previously inserted signature authentication object 212.

Referring to FIGS. 2, 12 and 14, following execution of either block 492 or block 496 as appropriate, block 500 directs the processor circuit 52 to display further information including identifying information associated with the user who originally uttered the authentication voice sample stored in the voice byte stream field 222. In this regard, if a digital certificate was used and is stored in the digital certificate field 216, block 500 directs the processor circuit 52 to extract from the digital certificate field 216 the name of the person or entity to whom the certificate was issued, a “valid from” date indicating the earliest date at which the digital certificate is valid, a “valid to” date indicating an expiry date of the digital certificate, and the name of the entity that issued the digital certificate. Referring to FIG. 13, block 500 directs the processor circuit to display this information in an “issued to” field 502, a “valid from” field 504, a “valid to” field 506, and an “issued by” field 508 respectively of the digital signatures dialogue window 495. Alternatively, if a digital certificate is not used and the digital certificate field 216 is empty, block 500 directs the processor circuit to display the contents of the user name field 220 in the “issued to” field 502 and to display an indication “n/a” in the fields 504, 506 and 508.

Referring to FIGS. 2, 12 and 14, in either case, block 500 directs the processor circuit 52 to display, in a date signed field 509 of the digital signatures dialogue window 495, the contents of the timestamp field 228 indicating the time at which the authentication voice sample was recorded, and to display within a time source field 510 an indication of whether the timestamp was obtained from a local or remote source as indicated by the contents of the remote time flag 230.

Block 500 further directs the processor circuit 52 to display a unique affirmation script indicative of expected contents of the authentication voice sample. To achieve this, block 500 directs the processor circuit to display the contents of the unique affirmation script field 226 in a unique affirmation script field 511 of the digital signatures dialogue window 495. Thus, a viewer of the file 205 may view the unique affirmation script, which in the embodiment is a textual representation of the expected unique utterance uttered by the user to create the authentication voice sample which has been associated with the file to indicate the user's approval of contents of the file.

Referring to FIG. 13, in this embodiment, the digital signatures dialogue window 495 further includes a plurality of command buttons, including a play script button 512, a details button 514 and an okay button 516.

Referring to FIGS. 2, 12 and 13, in this embodiment, while the digital signatures dialogue window 495 is open, block 520 directs the processor circuit 52 to determine whether the user has actuated the play script button 512, and if so, block 522 directs the processor circuit 52 to audibly play the authentication voice sample. In this embodiment, this is achieved by executing a sndPlaySound command to invoke a built-in function of the operating system 101 of the apparatus 50, which in this embodiment is a Windows 2000 operating system, to direct the processor circuit 52 to control the speakers 86 to audibly play back the authentication voice sample stored in the voice byte stream field 222.

Thus, a viewer of the open file 205 may listen to an audio playback of the authentication voice sample of a user (such as the user 58) which has been associated with the file 205 to indicate that user's approval of the contents of the file. If the viewer is familiar with the voice of the user, the viewer will be able to immediately confirm that the user 58 was in fact the person who approved the contents of the file. Similarly, the viewer may compare the audio playback of the authentication voice sample stored in the voice byte stream field 222 with the visual display of the corresponding unique affirmation script in the unique affirmation script field 511 shown in FIG. 13, to verify that the authentication voice sample is in fact an utterance of the unique affirmation script. If the viewer has reason to suspect that the authentication voice sample audibly played back is not the voice of the user 58 (voice matching) or alternatively if the authentication voice sample is not an utterance of the unique affirmation script (speech matching), the viewer will immediately be led to suspect that there is a risk that the file 205 was not duly approved by the user 58 or that it has been subsequently tampered with following such approval.

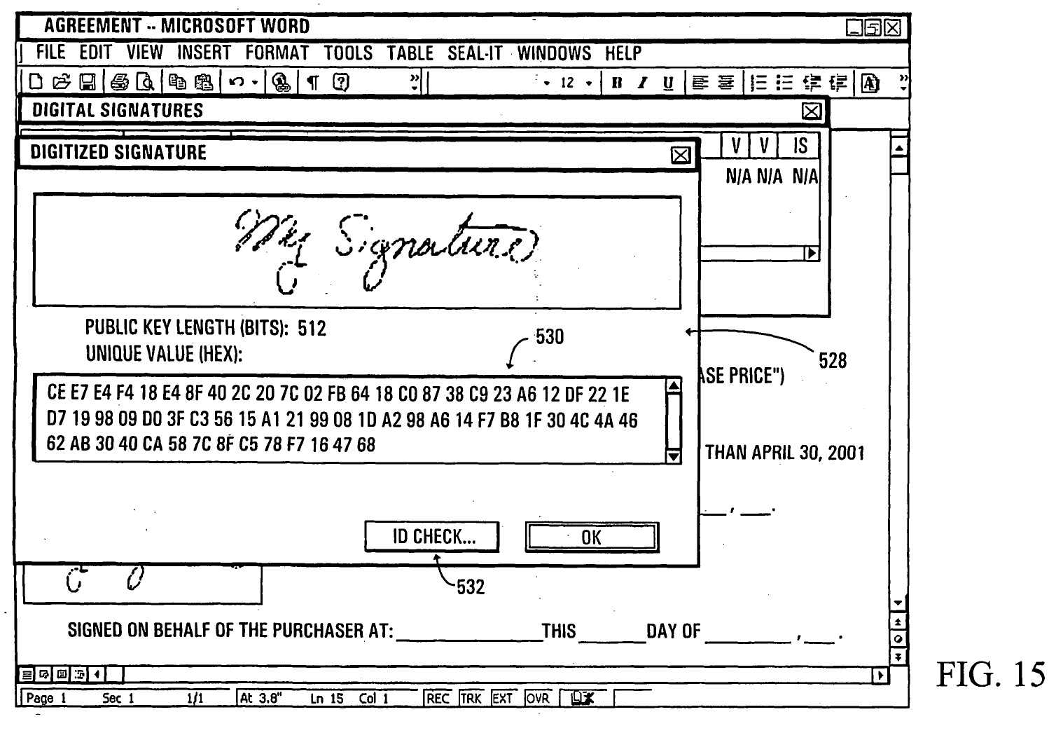

Referring to FIGS. 2, 12, 13 and 15, following execution of block 522, or alternatively if a playback command was not detected at block 520, block 524 directs the processor circuit 52 to determine whether the details button 514 has been actuated. If so, block 526 directs the processor circuit to display a signature details window, such as that shown generally at 528 in FIG. 15. In this embodiment, if the digital certificate field 216 contains a digital certificate which was used by the user to associate the user's authentication voice sample with the file, the signature details window 528 may display further detailed information (not shown) extracted from the digital certificate, which may include, for example, a serial number of the digital certificate, an algorithm associated with the digital certificate, a version identifier, and if desired, further information identifying the certificate issuer and the party to whom the certificate was issued, in greater detail.

Alternatively, if a digital certificate was not used and is not stored in the digital certificate field 216, block 526 directs the processor circuit 52 to display, in hexadecimal form, the public key stored in the public key field 218, in a public key field 530 of the signature details window 528. In this latter example, the signature details window 528 may additionally include an ID check button 532. In response to actuation of the ID check button 532, block 526 directs the processor circuit 52 to compare the public key field 218 contents to the public key stored in the authentication public/private key pair container 124 of the storage medium 100, to determine whether or not the public key originated from the particular apparatus 50. If the public key field 218 contents match the public key stored in the authentication public/private key pair container 124, block 526 directs a processor circuit to display a further window (not shown) indicating that the public key originated from the apparatus 50. Otherwise, block 526 directs the processor circuit to display an indication that the public key did not originate from this apparatus.

Following execution of block 526, or alternatively, if no details command was received at block 524, block 540 directs the processor circuit 52 to determine whether the okay button 516 shown in FIG. 13 has been actuated. If so, the processor circuit is directed to close the digital signatures dialogue window 495 and to continue processing at blocks 476, 480, 478 and 484 as described above. If no such okay command has been received, the processor circuit is directed to continue processing at blocks 520, 524 and 540 to await receipt of playback, details or okay commands respectively.

### Alternatives

### Other Applications and Files

Although the signature generation routine and signature authentication routine have been illustrated as being provided together, alternatively such routines may be provided separately.

Similarly, although the signature generation routine and signature authentication routine have been illustratively implemented as ActiveX controls, alternatively any other suitable codes for directing any type of processor circuit to carry out similar functions may be substituted.

Although the foregoing embodiment of the invention has been described in connection with Microsoft Word 2002 as an exemplary application program and Microsoft Word document (.doc) files as the exemplary files, alternatively, other embodiments of the invention may be employed, with or without different types of application programs, to associate authentication voice samples with other types of files. By way of illustration, for some applications it may be desirable to associate a user's authentication voice sample with a spreadsheet file such as a Microsoft Excel (.xls) file for example, with a hypertext markup language (.html) web-page, or with an e-mail message, for example. These and other such variations will be apparent to one of ordinary skill in the art when presented with this specification and are not considered to depart from the scope of the present invention as construed in accordance with the accompanying claims.

### Voice Comparison

Referring to FIGS. 2, 12, 13 and 18, if desired, the signature authentication routine 107 shown in FIG. 12 may be modified to include a voice comparison function. This function may be useful in situations where a party is attempting to repudiate his or her voice signature. It will be appreciated that this function would be unnecessary if the new hash value did not match the encrypted hash value at block 490 above, as the party's voice signature would be invalidated on that basis alone. However, if the hash values match at block 490, the possibility exists that a particular party may deny having provided the authentication voice sample, and may allege that the authentication voice sample is the voice of some other unauthorized person. To address this, the digital signatures dialogue window 495 shown in FIG. 13 may be modified to include a voice comparison command button 550, and the signature authentication viewer shown in FIG. 12 may be modified to include further command codes shown generally at 600, interposed between blocks 524 and 540, for example, to direct the processor circuit to detect actuation of the voice comparison command button 550.

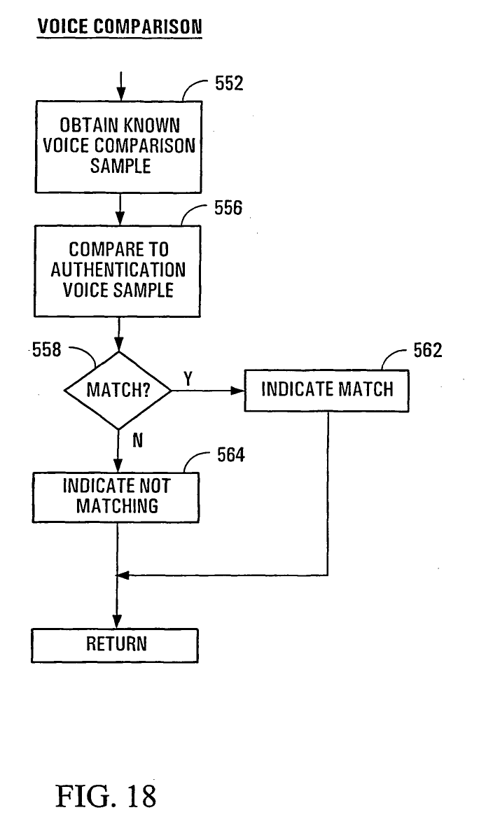

Upon detecting a voice comparison command, the blocks of codes 600 direct the processor circuit 52 to block 552 shown in FIG. 18, which directs the processor circuit to obtain a known comparison voice sample of the user 58 who supposedly approved the contents of the file 205 by associating his or her authentication voice sample therewith. Block 552 may direct the processor circuit to obtain such a voice sample by providing a browse window for example, to allow selection of a stored digitized known voice sample of the user, or alternatively, block 552 may generate and display recording command buttons such as those shown at 414 in FIG. 11, to allow a person to actuate the recording command buttons to use the microphone 76 to store a comparison voice sample. In this regard, the functionality of the record command buttons 414 is similar to that described above in connection with block 440 of the signing subroutine 105. In either case, whether the comparison voice sample is contained by browsing through previously stored files or is newly recorded, block 552 directs the processor circuit to store the comparison voice sample in a comparison voice sample register 554 of the RAM 200.

Blocks 556 and 558 then direct the processor circuit 52 to compare signals representing the authentication voice samples stored in the voice byte stream field 222 to signals representing the comparison voice sample stored in the comparison voice sample register 554, to determine whether or not the entire phrase, i.e., the entire duration of the authentication voice sample is identical to the comparison voice sample. In this embodiment, this is achieved by directing the processor circuit 52 to execute an existing voice comparison routine, such as that shown at 560 in FIG. 2. More particularly, in this embodiment the voice comparison routine is a Biometric Application Programming Interface (BioAPI) built into the operating system 101 of the system 50, which in this embodiment is a Microsoft Windows operating system available from Microsoft Corporation of Redmond, Wash., USA.

Depending on the outcome of the voice comparison performed by the processor circuit 52 under the direction of the voice comparison routine 560, blocks 562 or 564 direct the processor circuit 52 to indicate either that the authentication voice sample does or does not match the comparison voice sample, respectively. Processing may then be return to block 540 to await further actuation of command button shown in FIG. 13.

### Speech Comparison

Referring back to FIGS. 2 and 8, in embodiments where the unique affirmation script represents a textual phrase, speech-to-text verification may be employed, to verify that the user has correctly enunciated an audible and recognizable rendition of the unique affirmation script. For example, in an alternative embodiment of the invention, immediately following execution of block 440 discussed above, a new block 441 shown in FIG. 8 may be provided, which first directs the processor circuit 52 to speech-to-text convert the unique utterance to produce a textual representation of the unique utterance. More particularly, this is achieved by directing the processor circuit to call a speech-to-text converter 580 shown in FIG. 2, to analyze the contents of the authentication voice sample register 202, to produce a textual representation of the authentication voice sample spoken by the user 58, and to store the textual representation in a textual representation field 582 in the RAM 200. In this embodiment, the speech-to-text converter is a Microsoft Speech Application Programming Interface built into the Windows 2000 operating system 101. Block 441 then directs the processor circuit to compare the textual representation stored in the textual representation field 582 to the unique affirmation script stored in the unique affirmation script field 260, to verify that the user's authentication voice sample represents a recognizable utterance of the unique affirmation script. If the textual representation does not match the unique affirmation script, block 441 directs the processor circuit 52 to prompt the user to re-utter, as the unique utterance, the unique affirmation script. In other words, the user is prompted to try again, in which case the authentication voice sample is re-recorded as described earlier herein in connection with blocks 438 and 440. Thus, if the utterance by the user of the unique affirmation script was not recognizable by the speech-to-text converter for any reason, such as improper pronunciation by the user, or a faulty microphone, etc., then the user is prompted to re-record the authentication voice sample until the recorded authentication voice sample is a recognizable utterance of the unique affirmation script. It will be appreciated that this provides an extra degree of security against subsequent repudiation by the user of the user's approval of a particular file, as it precludes the user from arguing that the recorded authentication voice sample is not an utterance of the corresponding unique affirmation script which is uniquely associated with the particular file.

### Revision History

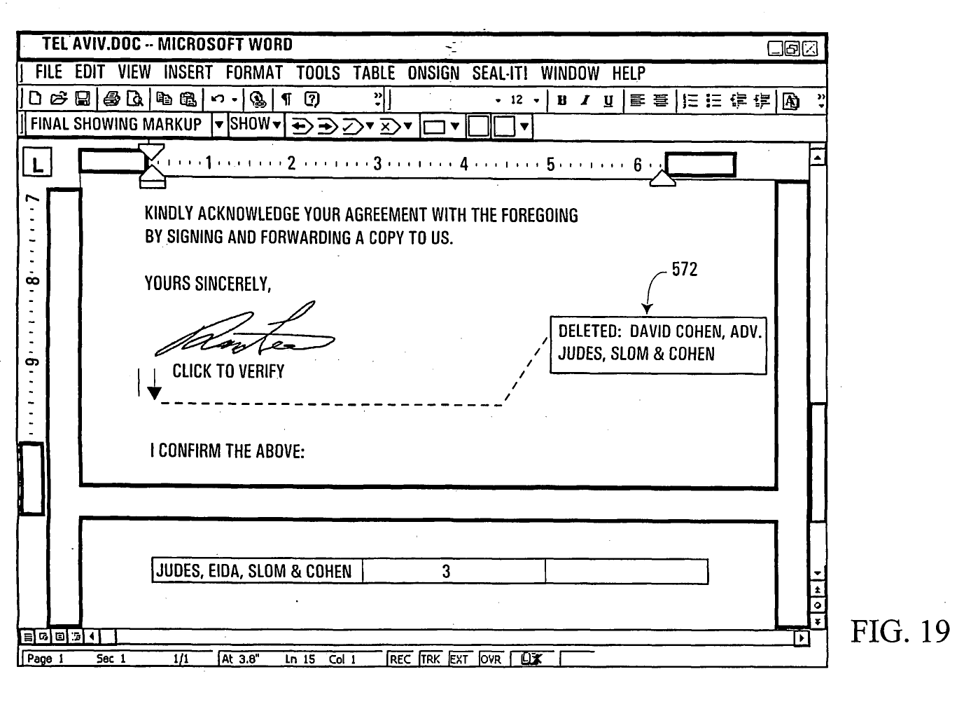

Referring to FIGS. 2, 9 and 19, if desired, the signing subroutine 105 may be modified to include an additional block of codes 570 shown in FIG. 9, to activate a revision history feature of the file 205 when the authentication voice sample as been associated with the file. Thus, referring to FIG. 19, once an authentication voice sample has been associated with the file 205, not only will subsequent changes to contents of the file, such as the text portion 208, for example, invalidate the authentication voice sample as discussed above in connection with blocks 490 and 496, but also, a viewer of the file 205 will be able to view revision history information such as that shown at 572 in FIG. 19 to be able to view the precise nature of the subsequent changes to the file which have invalidated the user's authentication voice sample.

More generally, while specific embodiments of the invention have been described and illustrated, such embodiments should be considered illustrative of the invention only and not as limiting the invention as construed in accordance with the accompanying claims.

What is claimed is:

1. An authentication method comprising:
receiving an authentication voice sample of a user of a file; and
associating said authentication voice sample with said file to indicate approval by said user of contents of said file.

2. The method of claim 1 wherein associating comprises associating, as said authentication voice sample, a unique utterance uttered by the user.

3. The method of claim 2 wherein associating a unique utterance comprises generating a unique affirmation script.

4. The method of claim 3 wherein generating said unique affirmation script comprises randomly selecting an entry in a lexicon.

5. The method of claim 4 wherein randomly selecting comprises generating a random number and using said number to address an entry location in said lexicon.

6. The method of claim 3 wherein generating said unique affirmation script comprises generating a random phrase.

7. The method of claim 6 wherein generating a random phrase comprises generating a random sentence.

8. The method of claim 3 wherein generating a unique affirmation script comprises randomly selecting a plurality of words and assembling said words into said script.

9. The method of claim 8 wherein randomly selecting a plurality of words comprises randomly selecting a verb from a verb lexicon.

10. The method of claim 8 wherein randomly selecting a plurality of words comprises randomly selecting a noun from a noun lexicon.

11. The method of claim 8 wherein randomly selecting a plurality of words comprises randomly selecting an adjective from an adjective lexicon.

12. The method of claim 8 wherein randomly selecting a plurality of words comprises randomly selecting a preposition from a preposition lexicon.

13. The method of claim 3 further comprising prompting said user to utter, as said unique utterance, said unique affirmation script.

14. The method of claim 13 further comprising speech-to-text converting said unique utterance to produce a textual representation of said unique utterance.

15. The method of claim 14 further comprising comparing said textual representation to said unique affirmation script.

16. The method of claim 15 further comprising prompting said user to re-utter, as said unique utterance, said unique affirmation script, if said textual representation does not match said unique affirmation script.

17. The method of claim 1 wherein associating comprises storing said authentication voice sample in association with said file.

18. The method of claim 17 wherein storing comprises receiving signals produced in response to an utterance by said user and storing, as said authentication voice sample, data representing said signals.

19. The method of claim 17 wherein storing comprises storing said sample in association with an object in said file.

20. The method of claim 19 wherein storing comprises storing said sample in association with a representation of a signature of said user.

21. The method of claim 17 wherein storing comprises storing said sample in said file.

22. The method of claim 21 wherein storing said sample in said file comprises storing said sample in an embedded stream in said file.

23. The method of claim 22 wherein storing in an embedded stream comprises storing said sample in an object pool portion of a document file.

24. The method of claim 17 further comprising storing a timestamp in association with said authentication voice sample.

25. The method of claim 24 further comprising retrieving said timestamp from a remote time server.

26. The method of claim 17 further comprising storing a validation value in association with said authentication voice sample.

27. The method of claim 26 further comprising generating said validation value in response to contents of said file.

28. The method of claim 27 wherein generating said validation value comprises executing a hashing function to produce a digital digest as said validation value.

29. The method of claim 27 wherein generating comprises generating said validation value in response to a unique affirmation script portion of said file.

30. The method of claim 27 wherein generating comprises generating said validation value in response to contents of a text portion, a unique affirmation script portion, a signature image portion and an authentication voice sample portion of said file.

31. The method of claim 27 wherein generating comprises generating said validation value in response to contents of said file excluding authentication objects comprising further authentication voice samples other than said authentication voice sample.

32. The method of claim 26 wherein storing said validation value comprises encrypting said validation value to produce an encrypted validation value and storing said encrypted validation value in association with said authentication voice sample.

33. The method of claim 17 further comprising storing a hyperlink in association with said authentication voice sample.

34. The method of claim 17 further comprising activating a revision history feature of said file when said authentication voice sample has been associated with said file.

35. The method of claim 1 further comprising validating said authentication voice sample.

36. The method of claim 35 wherein validating comprises indicating invalidity of said authentication voice sample if approved contents of said file have changed subsequent to association of said authentication voice sample with said file to approve said approved contents.

37. An authentication method comprising:
receiving an authentication voice sample, of a user of a file, associated with said file to indicate approval by said user of contents of said file; and
validating said authentication voice sample.

38. The method of claim 37 wherein validating comprises audibly playing said authentication voice sample.

39. The method of claim 38 wherein validating further comprises displaying a unique affirmation script indicative of expected contents of said authentication voice sample.

40. The method of claim 37 wherein validating comprises indicating invalidity of said authentication voice sample if approved contents of said file have changed subsequent to association of said authentication voice sample with said file to approve said approved contents.

41. The method of claim 37 wherein validating comprises generating a validation value in response to contents of said file and comparing said validation value to a stored validation value associated with said authentication voice sample.

42. The method of claim 41 wherein generating said validation value comprises executing a hashing function to produce a digital digest as said validation value.

43. The method of claim 41 wherein generating comprises generating said validation value in response to a unique affirmation script portion of said file.

44. The method of claim 41 wherein generating comprises generating said validation value in response to contents of a text portion, a unique affirmation script portion, a signature image portion and an authentication voice sample portion of said file.

45. The method of claim 41 wherein generating comprises generating said validation value in response to contents of said file excluding authentication objects that comprise authentication voice samples other than said authentication voice sample.

46. The method of claim 41 wherein validating further, comprises decrypting an encrypted stored validation value to extract said stored validation value.

47. The method of claim 41 wherein validating further comprises indicating validity of said authentication voice sample if said validation value matches said stored validation value, and otherwise indicating invalidity of said authentication voice sample.

48. The method of claim 41 wherein validating comprises comparing signals representing said authentication voice sample to signals representing a comparison voice sample of said user.

49. An authentication apparatus comprising:
means for receiving an authentication voice sample of a user of a file; and
means for associating said authentication voice sample with said file to indicate approval by said user of contents of said file.

50. The apparatus of claim 49 wherein said means for associating comprises means for associating, as said authentication voice sample, a unique utterance uttered by the user.

51. The apparatus of claim 50 wherein said means for associating a unique utterance comprises means for generating a unique affirmation script.

52. The apparatus of claim 51 wherein said means for generating said unique affirmation script comprises means for randomly selecting an entry in a lexicon.

53. The apparatus of claim 52 wherein said means for randomly selecting comprises means for generating a random number and using said number to address an entry location in said lexicon.

54. The apparatus of claim 51 wherein said means for generating said unique affirmation script comprises means for generating a random phrase.

55. The apparatus of claim 54 wherein said means for generating a random phrase comprises means for generating a random sentence.

56. The apparatus of claim 51 wherein said means for generating a unique affirmation script comprises means for randomly selecting a plurality of words and assembling said words into said script.

57. The apparatus of claim 56 wherein said means for randomly selecting a plurality of words comprises means for randomly selecting a verb from a verb lexicon.

58. The apparatus of claim 56 wherein said means for randomly selecting a plurality of words comprises means for randomly selecting a noun from a noun lexicon.

59. The apparatus of claim 56 wherein said means for randomly selecting a plurality of words comprises means for randomly selecting an adjective from an adjective lexicon.

60. The apparatus of claim 56 wherein said means for randomly selecting a plurality of words comprises means for randomly selecting a preposition from a preposition lexicon.

61. The apparatus of claim 51 further comprising means for prompting said user to utter, as said unique utterance, said unique affirmation script.

62. The apparatus of claim 61 further comprising means for speech-to-text converting said unique utterance to produce a textual representation of said unique utterance.

63. The apparatus of claim 62 further comprising means for comparing said textual representation to said unique affirmation script.

64. The apparatus of claim 63 further comprising means for prompting said user to re-utter, as said unique utterance, said unique affirmation script, if said textual representation does not match said unique affirmation script.

65. The apparatus of claim 49 wherein said means for associating comprises means for storing said authentication voice sample in association with said file.

66. The apparatus of claim 65 wherein said means for storing comprises means for receiving signals produced in response to an utterance by said user and for storing, as said authentication voice sample, data representing said signals.

67. The apparatus of claim 65 wherein said means for storing comprises means for storing said sample in association with an object in said file.

68. The apparatus of claim 67 wherein said means for storing comprises means for storing said sample in association with a representation of a signature of said user.

69. The apparatus of claim 65 wherein said means for storing comprises means for storing said sample in said file.

70. The apparatus of claim 69 wherein said means for storing said sample in said file comprises means for storing said sample in an embedded stream in said file.

71. The apparatus of claim 70 wherein said means for storing in an embedded stream comprises means for storing said sample in an object pool portion of a document file.

72. The apparatus of claim 65 further comprising means for storing a timestamp in association with said authentication voice sample.

73. The apparatus of claim 72 further comprising means for retrieving said timestamp from a remote time server.

74. The apparatus of claim 65 further comprising means for storing a validation value in association with said authentication voice sample.

75. The apparatus of claim 74 further comprising means for generating said validation value in response to contents of said file.

76. The apparatus of claim 75 wherein said means for generating said validation value comprises means for executing a hashing function to produce a digital digest as said validation value.

77. The apparatus of claim 75 wherein said means for generating comprises means for generating said validation value in response to a unique affirmation script portion of said file.

78. The apparatus of claim 75 wherein said means for generating comprises means for generating said validation value in response to contents of a text portion, a unique affirmation script portion, a signature image portion and an authentication voice sample portion of said file.

79. The apparatus of claim 75 wherein said means for generating comprises means for generating said validation value in response to contents of said file excluding authentication objects that comprise authentication voice samples other than said authentication voice sample.

80. The apparatus of claim 74 wherein said means for storing said validation value comprises means for encrypting said validation value to produce an encrypted validation value and for storing said encrypted validation value in association with said authentication voice sample.

81. The apparatus of claim 65 further comprising means for storing a hyperlink in association with said authentication voice sample.

82. The apparatus of claim 65 further comprising means for activating a revision history feature of said file when said authentication voice sample has been associated with said file.

83. The apparatus of claim 49 further comprising means for validating said authentication voice sample.

84. The apparatus of claim 83 wherein said means for validating comprises means for indicating invalidity of said authentication voice sample if approved contents of said file have changed subsequent to association of said authentication voice sample with said file to approve said approved contents.

85. An authentication apparatus comprising:
means for receiving an authentication voice sample, of a user of a file, associated with said file to indicate approval by said user of contents of said file; and
means for validating said authentication voice sample.

86. The apparatus of claim 85 wherein said means for validating comprises means for audibly playing said authentication voice sample.

87. The apparatus of claim 86 wherein said means for validating further comprises means for displaying a unique affirmation script indicative of expected contents of said authentication voice sample.

88. The apparatus of claim 85 wherein said means for validating comprises means for indicating invalidity of said authentication voice sample if approved contents of said file have changed subsequent to association of said authentication voice sample with said file to approve said approved contents.

89. The apparatus of claim 85 wherein said means for validating comprises means for generating a validation value in response to contents of said file and for comparing said validation value to a stored validation value associated with said authentication voice sample.

90. The apparatus of claim 89 wherein said means for generating a validation value comprises means for executing a hashing function to produce a digital digest as said validation value.

91. The apparatus of claim 89 wherein said means for generating comprises means for generating said validation value in response to a unique affirmation script portion of said file.

92. The apparatus of claim 89 wherein said means for generating comprises means for generating said validation value in response to contents of a text portion, a unique affirmation script portion, a signature image portion and an authentication voice sample portion of said file.

93. The apparatus of claim 89 wherein said means for generating comprises means for generating said validation value in response to contents of said file excluding authentication objects that comprise authentication voice samples other than said authentication voice sample.

94. The apparatus of claim 89 wherein said means for validating further comprises means for decrypting an encrypted stored validation value to extract said stored validation value.

95. The apparatus of claim 89 wherein said means for validating further comprises means for indicating validity of said authentication voice sample if said validation value matches said stored validation value, and for otherwise indicating invalidity of said authentication voice sample.

96. The apparatus of claim 89 wherein said means for validating comprises means for comparing signals representing said authentication voice sample to signals representing a comparison voice sample of said user.

97. A computer-readable medium storing codes for directing a processor circuit to:
receive an authentication voice sample of a user of a file; and
associate said authentication voice sample with said file to indicate approval by said user of contents of said file.

98. The medium of claim 97 wherein said codes direct said processor circuit to associate, as said authentication voice sample, a unique utterance uttered by the user.

99. The medium of claim 98 wherein said codes direct said processor circuit to generate a unique affirmation script.

100. The medium of claim 99 wherein said codes direct said processor circuit to randomly select an entry in a lexicon.

101. The medium of claim 100 wherein said codes direct said processor circuit to generate a random number and to use said number to address an entry location in said lexicon.

102. The medium of claim 99 wherein said codes direct said processor circuit to generate a random phrase.

103. The medium of claim 102 wherein said codes direct said processor circuit to generate a random sentence.

104. The medium of claim 99 wherein said codes direct said processor circuit to randomly select a plurality of words and to assemble said words into said script.

105. The medium of claim 104 wherein said codes direct said processor circuit to randomly select a verb from a verb lexicon.

106. The medium of claim 104 wherein said codes direct said processor circuit to randomly select a noun from a noun lexicon.

107. The medium of claim 104 wherein said codes direct said processor circuit to randomly select an adjective from an adjective lexicon.

108. The medium of claim 104 wherein said codes direct said processor circuit to randomly select a preposition from a preposition lexicon.

109. The medium of claim 99 wherein said codes direct said processor circuit to prompt said user to utter, as said unique utterance, said unique affirmation script.

110. The medium of claim 109 wherein said codes direct said processor circuit to speech-to-text convert said unique utterance to produce a textual representation of said unique utterance.

111. The medium of claim 110 wherein said codes direct said processor circuit to compare said textual representation to said unique affirmation script.

112. The medium of claim 111 wherein said codes direct said processor circuit to prompt said user to re-utter, as said unique utterance, said unique affirmation script, if said textual representation does not match said unique affirmation script.

113. The medium of claim 97 wherein said codes direct said processor circuit to store said authentication voice sample in association with said file.

114. The medium of claim 113 wherein said codes direct said processor circuit to receive signals produced in response to an utterance by said user and to store, as said authentication voice sample, data representing said signals.

115. The medium of claim 113 wherein said codes direct said processor circuit to store said sample in association with an object in said file.

116. The medium of claim 115 wherein said codes direct said processor circuit to store said sample in association with a representation of a signature of said user.

117. The medium of claim 113 wherein said codes direct said processor circuit to store said sample in said file.

118. The medium of claim 117 wherein said codes direct said processor circuit to store said sample in an embedded stream in said file.

119. The medium of claim 118 wherein said codes direct said processor circuit to store said sample in an object pool portion of a document file.

120. The medium of claim 113 wherein said codes direct said processor circuit to store a timestamp in association with said authentication voice sample.

121. The medium of claim 120 wherein said codes direct said processor circuit to retrieve said timestamp from a remote time server.

122. The medium of claim 113 wherein said codes direct said processor circuit to store a validation value in association with said authentication voice sample.

123. The medium of claim 122 wherein said codes direct said processor circuit to generate said validation value in response to contents of said file.

124. The medium of claim 123 wherein said codes direct said processor circuit to execute a hashing function to produce a digital digest as said validation value.

125. The medium of claim 123 wherein said codes direct said processor circuit to generate said validation value in response to contents of a unique affirmation script portion of said file.

126. The medium of claim 123 wherein said codes direct said processor circuit to generate said validation value in response to contents of a text portion, a unique affirmation script portion, a signature image portion and an authentication voice sample portion of said file.

127. The medium of claim 123 wherein said codes direct said processor circuit to generate said validation value in response to contents of said file excluding authentication objects that comprise authentication voice samples other than said authentication voice sample.

128. The medium of claim 122 wherein said codes direct said processor circuit to encrypt said validation value to produce an encrypted validation value and to store said encrypted validation value in association with said authentication voice sample.

129. The medium of claim 113 wherein said codes direct said processor circuit to store a hyperlink in association with said authentication voice sample.

130. The medium of claim 113 wherein said codes direct said processor circuit to activate a revision history feature of said file when said authentication voice sample has been associated with said file.

131. The medium of claim 97 wherein said codes direct said processor circuit to validate said authentication voice sample.

132. The medium of claim 131 wherein said codes direct said processor circuit to indicate invalidity of said authentication voice sample if approved contents of said file have changed subsequent to association of said authentication voice sample with said file to approve said approved contents.

133. A computer-readable medium storing codes for directing a processor circuit to:
receive an authentication voice sample of a user of a file, associated with said file to indicate approval by said user of contents of said file; and
validate said authentication voice sample.

134. The medium of claim 133 wherein said codes direct said processor circuit to audibly play said authentication voice sample.

135. The medium of claim 134 wherein said codes direct said processor circuit to display a unique affirmation script indicative of expected contents of said authentication voice sample.

136. The medium of claim 133 wherein said codes direct said processor circuit to indicate invalidity of said authentication voice sample if approved contents of said file have changed subsequent to association of said authentication voice sample with said file to approve said approved contents.

137. The medium of claim 133 wherein said codes direct said processor circuit to generate a validation value in response to contents of said file and to compare said validation value to a stored validation value associated with said authentication voice sample.

138. The medium of claim 137 wherein said codes direct said processor circuit to execute a hashing function to produce a digital digest as said validation value.

139. The medium of claim 137 wherein said codes direct said processor circuit to generate said validation value in response to a unique affirmation script portion of said file.

140. The medium of claim 137 wherein said codes direct said processor circuit to generate said validation value in response to contents of a text portion, a unique affirmation script portion, a signature image portion and an authentication voice sample portion of said file.

141. The medium of claim 137 wherein said codes direct said processor circuit to generate said validation value in response to contents of said file excluding authentication objects that comprise authentication voice samples other than said authentication voice sample.

142. The medium of claim 137 wherein said codes direct said processor circuit to decrypt an encrypted stored validation value to extract said stored validation value.

143. The medium of claim 137 wherein said codes direct said processor circuit to indicate validity of said authentication voice sample if said validation value matches said stored validation value, and to otherwise indicate invalidity of said authentication voice sample.

144. The medium of claim 137 wherein said codes direct said processor circuit to compare signals representing said authentication voice sample to signals representing a comparison voice sample of said user.

145. A signal embodied in a carrier wave, the signal comprising code segments for directing a processor circuit to:
receive an authentication voice sample of a user of a file; and
associate said authentication voice sample with said file to indicate approval by said user of contents of said file.

146. The signal of claim 145 wherein said code segments direct said processor circuit to associate, as said authentication voice sample, a unique utterance uttered by the user.

147. The signal of claim 146 wherein said code segments direct said processor circuit to generate a unique affirmation script.

148. The signal of claim 147 wherein said code segments direct said processor circuit to randomly select an entry in a lexicon.

149. The signal of claim 148 wherein said code segments direct said processor circuit to generate a random number and to use said number to address an entry location in said lexicon.

150. The signal of claim 147 wherein said code segments direct said processor circuit to generate a random phrase.

151. The signal of claim 150 wherein said code segments direct said processor circuit to generate a random sentence.

152. The signal of claim 147 wherein said code segments direct said processor circuit to randomly select a plurality of words and to assemble said words into said script.

153. The signal of claim 152 wherein said code segments direct said processor circuit to randomly select a verb from a verb lexicon.

154. The signal of claim 152 wherein said code segments direct said processor circuit to randomly select a noun from a noun lexicon.

155. The signal of claim 152 wherein said code segments direct said processor circuit to randomly select an adjective from an adjective lexicon.

156. The signal of claim 152 wherein said code segments direct said processor circuit to randomly select a preposition from a preposition lexicon.

157. The signal of claim 147 wherein said code segments direct said processor circuit to prompt said user to utter, as said unique utterance, said unique affirmation script.

158. The signal of claim 157 wherein said code segments direct said processor circuit to speech-to-text convert said unique utterance to produce a textual representation of said unique utterance.

159. The signal of claim 158 wherein said code segments direct said processor circuit to compare said textual representation to said unique affirmation script.

160. The signal of claim 159 wherein said code segments direct said processor circuit to prompt said user to re-utter, as said unique utterance, said unique affirmation script, if said textual representation does not match said unique affirmation script.

161. The signal of claim 145 wherein said code segments direct said processor circuit to store said authentication voice sample in association with said file.

162. The signal of claim 161 wherein said code segments direct said processor circuit to receive signals produced in response to an utterance by said user and to store, as said authentication voice sample, data representing said signals.

163. The signal of claim 161 wherein said code segments direct said processor circuit to store said sample in association with an object in said file.

164. The signal of claim 163 wherein said code segments direct said processor circuit to store said sample in association with a representation of a signature of said user.

165. The signal of claim 161 wherein said code segments direct said processor circuit to store said sample in said file.

166. The signal of claim 165 wherein said code segments direct said processor circuit to store said sample in an embedded stream in said file.

167. The signal of claim 166 wherein said code segments direct said processor circuit to store said sample in an object pool portion of a document file.

168. The signal of claim 161 wherein said code segments direct said processor circuit to store a timestamp in association with said authentication voice sample.

169. The signal of claim 168 wherein said code segments direct said processor circuit to retrieve said timestamp from a remote time server.

170. The signal of claim 161 wherein said code segments direct said processor circuit to store a validation value in association with said authentication voice sample.

171. The signal of claim 170 wherein said code segments direct said processor circuit to generate said validation value in response to contents of said file.

172. The signal of claim 171 wherein said code segments direct said processor circuit to execute a hashing function to produce a digital digest as said validation value.

173. The signal of claim 171 wherein said code segments direct said processor circuit to generate said validation value in response to a unique affirmation script portion of said file.

174. The signal of claim 171 wherein said code segments direct said processor circuit to generate said validation value in response to contents of a text portion, a unique affirmation script portion, a signature image portion and an authentication voice sample portion of said file.

175. The signal of claim 171 wherein said code segments direct said processor circuit to generate said validation value in response to contents of said file excluding authentication objects that comprise authentication voice samples other than said authentication voice sample.

176. The signal of claim 170 wherein said code segments direct said processor circuit to encrypt said validation value to produce an encrypted validation value and to store said encrypted validation value in association with said authentication voice sample.

177. The signal of claim 161 wherein said code segments direct said processor circuit to store a hyperlink in association with said authentication voice sample.

178. The signal of claim 161 wherein said code segments direct said processor circuit to activate a revision history feature of said file when said authentication voice sample has been associated with said file.

179. The signal of claim 145 wherein said code segments direct said processor circuit to validate said authentication voice sample.

180. The signal of claim 179 wherein said code segments direct said processor circuit to indicate invalidity of said authentication voice sample if approved contents of said file have changed subsequent to association of said authentication voice sample with said file to approve said approved contents.

181. A signal embodied in a carrier wave, the signal comprising code segments for directing a processor circuit to:
receive an authentication voice sample of a user of a file, associated with said file to indicate approval by said user of contents of said file; and
validate said authentication voice sample.

182. The signal of claim 181 wherein said code segments direct said processor circuit to audibly play said authentication voice sample.

183. The signal of claim 182 wherein said code segments direct said processor circuit to display a unique affirmation script indicative of expected contents of said authentication voice sample.

184. The signal of claim 181 wherein said code segments direct said processor circuit to indicate invalidity of said authentication voice sample if approved contents of said file have changed subsequent to association of said authentication voice sample with said file to approve said approved contents.

185. The signal of claim 181 wherein said code segments direct said processor circuit to generate a validation value in response to contents of said file and to compare said validation value to a stored validation value associated with said authentication voice sample.

186. The signal of claim 185 wherein said code segments direct said processor circuit to execute a hashing function to produce a digital digest as said validation value.

187. The signal of claim 186 wherein said code segments direct said processor circuit to generate said validation value in response to a unique affirmation script portion of said file.

188. The signal of claim 185 wherein said code segments direct said processor circuit to generate said validation value in response to contents of a text portion, a unique affirmation script portion, a signature image portion and an authentication voice sample portion of said file.

189. The signal of claim 185 wherein said code segments direct said processor circuit to generate said validation value in response to contents of said file excluding authentication objects that comprise authentication voice samples other than said authentication voice sample.

190. The signal of claim 185 wherein said code segments direct said processor circuit to decrypt an encrypted stored validation value to extract said stored validation value.

191. The signal of claim 185 wherein said code segments direct said processor circuit to indicate validity of said authentication voice sample if said validation value matches said stored validation value, and to otherwise indicate invalidity of said authentication voice sample.

192. The signal of claim 185 wherein said code segments direct said processor circuit to compare signals representing said authentication voice sample to signals representing a comparison voice sample of said user.

193. An authentication apparatus comprising a processor circuit configured to:
receive an authentication voice sample of a user of a file; and
associate said authentication voice sample with said file to indicate approval by said user of contents of said file.

194. An authentication apparatus comprising a processor circuit configured to:
receive an authentication voice sample, of a user of a file, associated with said file to indicate approval by said user of contents of said file; and
validate said authentication voice sample.
